(19) United States
(12) Patent Application Publication
(10) Pub. No.: US 2004/0223684 A1
(43) Pub. Date: Nov. 11, 2004

(54) Calibration of optical cross-connect switches

(75) Inventors: Daniel R. Weinkam, Coquitlam (CA); Thomas W. Steiner, Burnaby (CA)

Correspondence Address: OYEN, WIGGS, GREEN & MUTALA, 480 - THE STATION, 601 WEST CORDOVA STREET, VANCOUVER, BC, V6B 1G1, CA

(73) Assignee: Creo SRL, St. James (BB)

(21) Appl. No.: 10/434,153

(22) Filed: May 9, 2003

(51) Int. Cl. G02B 6/35

(52) U.S. Cl. 385/16

(57) ABSTRACT

An optical cross connect switch includes a number of monitor channels. The monitor channels can be used to calibrate the switch while it is in operation. The coordinates associated with individual channels of the switching unit may be represented in a common coordinate system. Transformations between the common coordinate system and coordinate systems of individual channels may be adjusted to compensate for drift.

### TECHNICAL FIELD

The invention relates to switching optical signals and, in particular, to calibrating optical cross-connect (“OXC”) switches.

### BACKGROUND

Digital data, which may, for example, comprise voice, video or other data may be carried in optical communication signals. There are many tasks for which it is desirable to provide switches that permit optical signal paths to be interconnected in different ways.

OXC switches permit optical signals from any of a first group of one or more optical signal carriers, typically optical fibers, to be delivered to any of a second group of optical signal carriers. The first and second groups of optical signal carriers are typically said to be on first and second “sides” of the switch. The first and second sides are not necessarily spatially separated, although they may be. OXC switches establish optical connections between selected fibers on the first side and selected fibers on the second side. Fibers on either side of an OXC switch typically transmit and/or receive optical transmissions to/from fibers on the opposing side.

Typically, placing fiber pairs in mutual optical communication is achieved by changing the optical transmission pathways of optical signals across the switch. OXC switches typically have control systems, which identify pairs of fibers that are to be optically connected and operate actuator mechanisms to place the pairs of fibers in mutual optical communication.

Such control systems require calibration. The control system of an OXC switch may typically be calibrated during system initialization, during or after system reconfiguration, after replacement of one or more fibers, and/or during operation to overcome long term “drift” (i.e. changes in the electrical, mechanical and/or optical characteristics) of various switch components.

There is a general need for OXC switches which can operate reliably and for apparatus and methods for calibrating control systems for OXC switches.

### SUMMARY OF THE INVENTION

One aspect of the invention provides a method for calibrating an optical switch. The method comprises establishing optical connections between a first optical signal carrier and each of a plurality of optical devices. The method involves determining coordinates associated with the optical device in a local coordinate system of the first optical signal carrier (from a control system corresponding to the first optical signal carrier) and computing a transformation between the local coordinate system of the first optical signal carrier and a second coordinate system based on the determined coordinates.

In some embodiments of the invention, the optical devices are monitor channels.

After calibration, an optical connection may be established between a selected one of a plurality of other optical signal carriers and the first optical signal carrier by using the transformation to transform coordinates associated with the selected other optical signal carrier from the second coordinate system to local coordinates in the local coordinate system of the first optical signal carrier and moving an optical element corresponding to the first optical signal carrier in response to the local coordinates.

In specific embodiments of the invention, the optical element comprises one or more of: a moveable lens, a moveable mirror, a moveable optical fiber and a moveable prism.

When the optical connection between the first optical signal carrier and the monitor channel is established, the calibration method may involve determining first coordinates associated with the first optical signal carrier in a local coordinate system of the monitor channel (from a control system corresponding to the monitor channel) and, based upon the first coordinates, determining second coordinates associated with the first optical signal carrier.

In some typical embodiments, the first optical signal carrier comprises a side A monitor channel and each of the plurality of optical devices comprises a side B monitor channel. Establishing optical connections between the first optical signal carrier and each of the plurality of optical devices may comprise establishing optical connections between the side A monitor channel and each of the plurality of side B monitor channels. When the optical connection is established with each optical device, determining coordinates associated with the optical device may comprise determining coordinates associated with the side B monitor channel in a local coordinate system of the side A monitor channel (from a control system corresponding to the side A monitor channel). Computing a transformation between the local coordinate system of the first optical signal carrier and the second coordinate system may comprise computing a transformation between the local coordinate system of the side A monitor channel and a side A coordinate system based upon the determined coordinates associated with the side B monitor channels.

The method may also involve providing a plurality of side A optical signal carriers and a plurality of side B optical signal carriers. Based upon the transformation, new calibration information relating to at least one of: the plurality of side A optical signal carriers and the plurality of side B optical signal carriers signal carriers may be generated and, if required, existing calibration information may be updated by replacing it with new calibration information.

Another aspect of the invention provides an optical cross-connect switch having a plurality of side A optical signal carriers, a plurality of side B optical signal carriers, one or more side A monitor channels and one or more side B monitor channels. The switch comprises: means for transmitting optical communication signals between any one of the side A optical signal carriers and any one of the side B optical signal carriers and a controller connected to the one or more side A monitor channels and the one or more side B monitor channels and configured to generate optical connections between the one or more side A monitor channels and the one or more side B monitor channels without disturbing transmission of optical communication signals between the side A optical signal carriers and the side B optical signal carriers and to use information obtained from these optical connections to update calibration information relating to at least one of: the plurality of side A optical signal carriers and the plurality of side B optical signal carriers.

The invention is not limited to the foregoing aspects. Further aspects of the invention and features of specific embodiments of the invention are described below.

### BRIEF DESCRIPTION OF THE DRAWINGS

In drawings which illustrate non-limiting embodiments of the invention,

FIG. 1 is a block diagram showing major components of a typical control system for an OXC switch;

FIG. 2 depicts a particular embodiment of an OXC switch architecture;

FIG. 3 is a front elevation view of one side of an OXC switch according to a particular embodiment of the invention;

FIG. 4 is a sectional side elevation view of a switching unit according to a particular embodiment of the invention;

FIGS. 5A and 5B are schematic diagrams that depict optical communication signals being focused and transmitted across a switch interface between switching units of the type shown in FIG. 4;

FIG. 6 is a sectional side elevation view of a monitor channel according to a particular embodiment of the invention;

FIG. 7 is a schematic block diagram showing an example of a method for calibrating a new switching unit;

FIG. 8 is a schematic diagram showing the major components involved in the method of FIG. 7;

FIG. 9 is a schematic block diagram showing an example of a method for initializing the monitor channels of an OXC switch;

FIG. 10 is a schematic diagram showing the major components involved in the method of FIG. 9;

FIG. 11 is a schematic block diagram showing an example of a method for recalibrating an OXC switch to overcome drift associated with the various switch components; and,

FIG. 12 is a schematic block diagram showing an example of a method for using photodetectors to generate approximate coordinate transformations.

### DESCRIPTION

Throughout the following description, specific details are set forth in order to provide a more thorough understanding of the invention. However, the invention may be practiced without these particulars. In other instances, well known elements have not been shown or described in detail to avoid unnecessarily obscuring the invention. Accordingly, the specification and drawings are to be regarded in an illustrative, rather than a restrictive, sense.

In this description, two optical signal carriers (e.g. fibers) in a switch are on “opposing sides” if the switch can optically couple the signal carriers. Optical signal carriers may transmit or receive optical communication signals, or both. The exemplary embodiments described herein use optical fibers as optical signal carriers. Throughout this description, a first side of an OXC switch is referred to as “side A” and the side of the switch opposing side A is referred to as “side B”. Switch components related to side A are referred to as “side A components” and those related to side B are referred to as “side B components”. Side A components are identified using numerals and/or characters (for example, side A fiber 12). Similar components on side B are identified by the same numerals and/or characters followed by a “prime” symbol (for example, side B fiber 12′).

In this description, “communication signal” means a radiation beam which can be modulated to carry data of any kind. A communication signal may be uni-directional and/or bi-directional. Communication signals also include non-modulated radiation beams. Typical communication signals have wavelengths such as λ=1310 nm and λ=1550 nm. However, switches incorporating the calibration apparatus and methods of the present invention may handle communication signals of any practical wavelengths.

An OXC switch controller makes an optical connection by establishing an optical path so that an optical communication signal emanating from a side A fiber is coupled to a side B fiber. After such an optical connection has been made, the side A fiber can transmit an optical communication signal to the side B fiber. The optical path typically also permits an optical communication signal to be transmitted from the side B fiber to the side A fiber. In the embodiments of the invention described herein the controller moves the ends of side A and side B fibers such that an optical communication signal emanating from the side A fiber crosses the switch and is coupled into the core of the side B fiber. When such an optical connection has been established, the side A fiber can be said to be “aligned” with the side B fiber and vice versa.

In this description, “calibration” of an OXC switch refers to obtaining sufficient information to permit the controller to cause optical communication signals to travel between a selected side A fiber and a selected side B fiber. The calibration of a switch is optimized when the optical power loss across the switch is minimized (i.e. the transmission efficiency is maximized). In this disclosure, the word “minimize” and derivatives thereof are intended to mean below an acceptably low level. Similarly, the word “maximize” and its derivatives mean above an acceptably high level.

A switch according to an exemplary embodiment of the invention has a plurality of monitor channels. Each monitor channel comprises an optical signal carrier (e.g. an optical fiber) which can be optically connected to optical signal carriers on an opposing side of the switch. The monitor channels can be used for calibration. For example, upon the addition of a new side B fiber to the switch, a controller may cause an optical connection to be established between one or more side A monitor channels and the new side B fiber. Preferably, the controller sequentially establishes optical connections between each of a plurality of side A monitor channels and the new side B fiber. The controller uses information obtained in establishing these optical connections to determine coordinates (preferably, in a side A global coordinate system). These coordinates may be use in optically coupling side A fibers to the new side B fiber. These coordinates may be referred to as the position or coordinates associated with the new side B fiber in the side A global coordinate system. The controller may combine (for example, by averaging) information obtained through use of two or more side A monitor channels to establish values for these coordinates. Preferably, the controller stores the values for these coordinates in a memory. The controller may subsequently use the coordinates associated with the new side B fiber in the side A global coordinate system for making an optical connection between any selected one of the side A fibers and the new side B fiber.

In making optical connections between the new side B fiber and the side A monitor channel(s), the controller may also obtain coordinates associated with each side A monitor channel in a local coordinate system of the new side B fiber. Using these coordinates, the controller may determine transformations back and forth between the local coordinate system of the new side B fiber and a side B coordinate system (which is preferably, a side B global coordinate system). The new side B fiber is then calibrated such that it may be aligned with any device (such as a selected side A fiber), provided that the position associated with the device is known in the side B coordinate system.

Monitor channels may also be used to update the calibration of the OXC switch from time to time to compensate for electronic, mechanical and/or optical drift of various switch components.

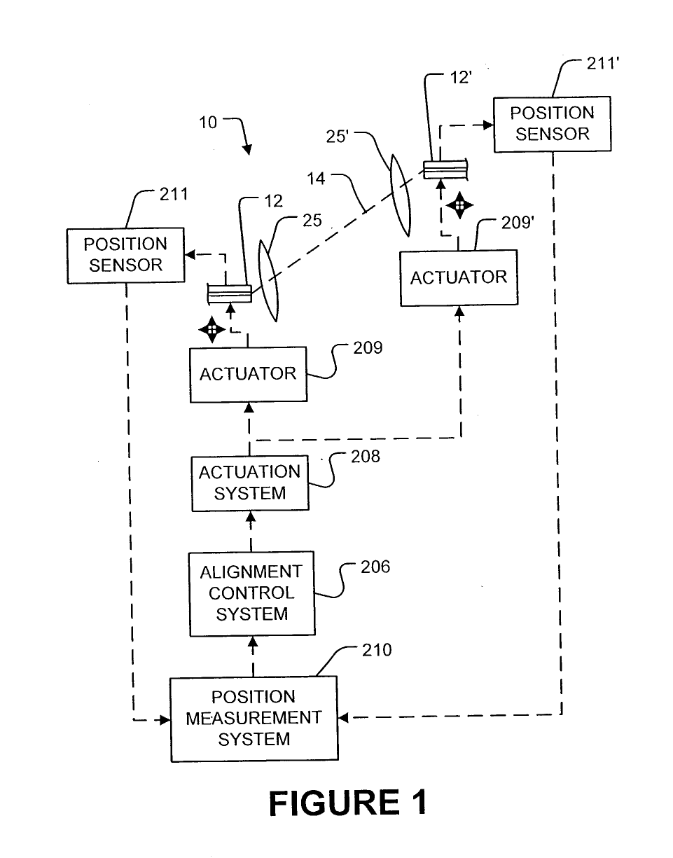

The invention may be applied to M×N type switches where M, N are integers. In such a switch, any one of a set of M side A optical fibers may be placed in optical communication with any one of a set of N side B optical fibers. FIG. 1 shows an example of a switch 10 comprising a set of side A optical fibers, which includes a selected side A optical fiber 12, and a set of side B optical fibers, which includes a selected side B optical fiber 12′. Switch 10 has an alignment control system 206. Alignment control system 206 identifies one of the M side A fibers to be optically connected to one of the N side B fibers in any suitable manner. For example, alignment control system 206 may receive (from an external source) commands which identify pairs of side A and side B optical fibers to place into optical communication with one another. In this example, selected side A fiber 12 is to be placed in optical communication with selected side B fiber 12′.

An optical connection between selected side A fiber 12 and selected side B fiber 12′ may be unidirectional, in either direction, or bidirectional. In this example, it is desired to transmit an optical communication signal from side A fiber 12 to side B fiber 12′.

Alignment control system 206 establishes an optical connection between selected side A fiber 12 and selected side B fiber 12′ by moving fibers 12, 12′ into positions such that radiation emitted from fiber 12 is coupled to the core of fiber 12′. When alignment control system 206 is directed to connect an optical signal from side A fiber 12 to side B fiber 12′, it retrieves the coordinates associated with side B fiber 12′ in the side A global coordinate system. Alignment control system 206 then transforms these coordinates into a local coordinate system of side A fiber 12 to obtain a target position for side A fiber 12 in its own local coordinate system. This target position for side A fiber 12 represents the coordinates associated with side B fiber 12′ in the local coordinate system of side A fiber 12. In a similar marmer, alignment control system 206 obtains a target position for side B fiber 12′ in its local coordinate system. This target position for side B fiber 12′ represents the coordinates associated with side A fiber 12 in the local coordinate system of side B fiber 12′.

Alignment control system 206 moves selected fibers 12, 12′ to their respective target positions. In the illustrated embodiment of the invention, alignment control system 206 implements closed-loop control. Alignment control system 206 receives information about the positions of fibers 12 and 12′ from position measurement system 210, calculates appropriate control signals based on the measured position information and the target positions for selected fibers 12, 12′, and outputs the control signals to actuation system 208. Position measurement system 210 uses position sensor 211 to measure the position of side A fiber 12 and position sensor 211′ to measure the position of side B fiber 12′. Alignment control system 206 may generate the control signals using any suitable control technique.

Alignment control system 206 outputs control signals to actuation system 208, which may amplify or otherwise process the control signals to generate actuator signals. Actuation system 208 delivers the actuator signals to actuators 209, 209′. In response to an actuator signal from actuation system 208, actuator 209 controllably moves selected side A fiber 12 to its target position. In this target position, side A fiber 12 is aligned such that it may propagate optical communication signals towards side B fiber 12′. At the same time, actuation system 208 provides an actuator signal to actuator 209′, which controllably moves selected side B fiber 12′ to its target position. In this target position, side B fiber 12′ is aligned to receive optical communication signals from side A fiber 12. An optical communication signal 14 can then be transmitted from side A fiber 12 to side B fiber 12′ (or vice versa).

Position measurement system 210 may include position sensors 211 corresponding to each of the M side A fibers and position sensors 211′ corresponding to each of the N side B fibers. Similarly, actuation system 208 may include actuators 209 corresponding to each of the M side A fibers and actuators 209′ corresponding to each of the N side B fibers.

Alignment control system 206, position measurement system 210 and actuation system 208 may be common to all side A fibers and all side B fibers. In an alternative embodiment, each side of switch 10 may have its own alignment control system, position measurement system and/or actuation system. In a further alternative embodiment, each fiber may have a corresponding alignment control system, position measurement system and/or actuation system. In addition, any such alignment control systems, actuation systems and/or position measurement systems may share components.

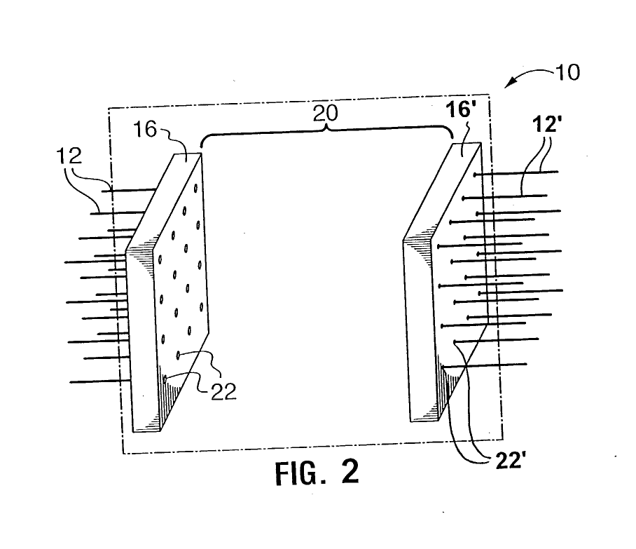

FIG. 2 is a schematic representation of one possible configuration for an M×N switch. FIG. 2 shows a 16×16 switch architecture. Switches according to this invention may have fewer fibers or many more than the example embodiments shown in FIG. 2. For example, a switch incorporating the calibration apparatus and methods of the invention may be 1024×1024 or even larger.

Switch 10 of FIG. 2 comprises a side A chassis 16 located directly opposite a side B chassis 16′. A plurality of side A fibers 12 are mounted in side A chassis 16. Each side A fiber 12 may be optically connected to any one of a plurality of side B fibers 12′ in side B chassis 16′. Once made, the optical connection between a side A fiber 12 and a side B fiber 12′ can carry an optical communication signal.

Side A chassis 16 and side B chassis 16′ are separated by a transmission cavity 20. Preferably, transmission cavity 20 is relatively empty of anything that might occlude the transmission of optical communication signals, so that communication signals may be transmitted between any of side A fibers 12 and any of side B fibers 12′. Each of fibers 12, 12′ corresponds to a switching unit 22, 22′. Switching units 22, 22′ are preferably modular and field interchangeable, such that a particular switching unit 22, 22′ may be easily removed and replaced with another switching unit 22, 22′. In some embodiments, switching units 22, 22′ may be grouped into modular and field interchangeable banks (not shown in FIG. 2), each bank containing a plurality of switching units 22, 22′. In such embodiments, each modular bank of switching units 22, 22′ may be removed and replaced with a new bank of switching units 22, 22′.

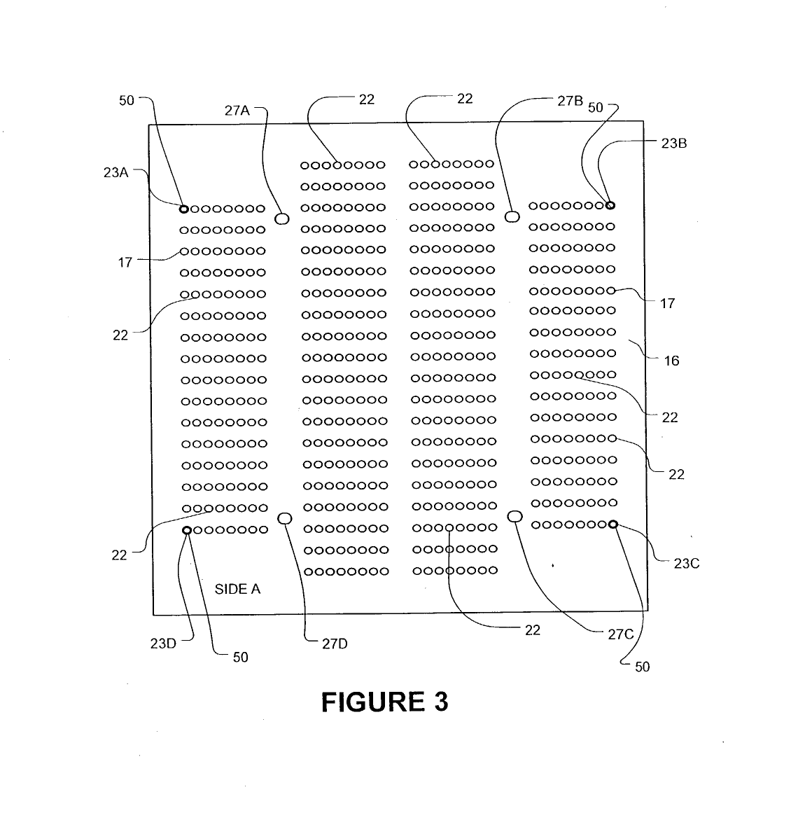

FIG. 3 depicts a particular embodiment of one side (side A) of an OXC switch according to the invention. Some switch components are omitted from FIG. 3 for clarity. Side A of the switch comprises a chassis 16, which houses a number of side A switching units 22 and a smaller number of side A monitor channels 23. In the illustrated embodiment, side A switching units 22 are grouped into 1×8 banks 17, each of which is mounted to chassis 16 by suitable fastening means (not shown). Preferably, banks 17 of switching units 22 are modular and field interchangeable, such that they may be individually removed from chassis 16 and replaced with a new bank. Individual side A monitor channels 23A, 23B, 23C, 23D are located at non-collinear, spaced apart positions. In the illustrated embodiment, the monitor channels are located among side A switching units 22. In the illustrated embodiment, side A of the switch includes a number of optional photodetectors 27. Side B may be constructed in a manner that is substantially similar to side A and may include switching units 22′ (not shown), monitor channels 23′ (not shown) and optional photodetectors 27′ (not shown), which are functionally similar to those of side A.

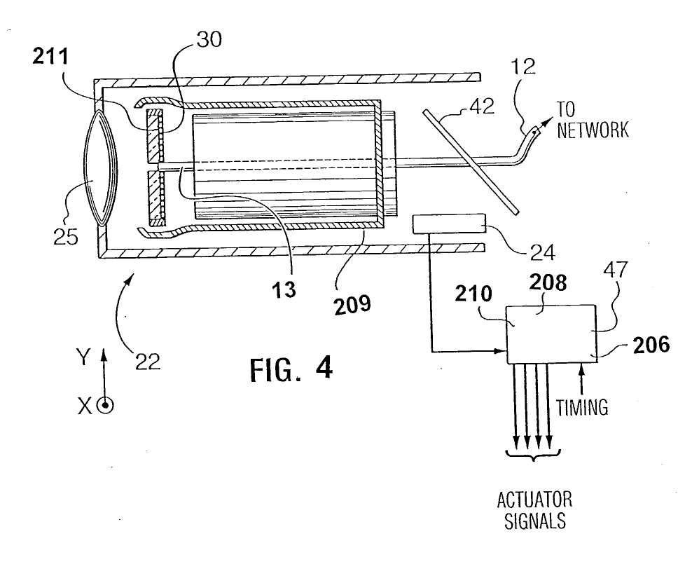

A particular embodiment of a side A switching unit 22 is shown in FIG. 4. Side B switching units 22′ may be substantially the same as side A switching unit 22 of FIG. 4. Each switching unit 22 comprises a fiber 12, having an end 13, and a lens 25. Lens 25 focuses radiation entering or exiting switching unit 22. In general, lens 25 may comprise any combination of one or more optical elements that provides these functions.

In the illustrated embodiment, alignment control system 206 comprises a controller 47. Controller 47 may comprise one or more programmable processor(s) which may include, without limitation, embedded microprocessors, dedicated computers, groups of data processors or the like. Some functions of processor 47 may be implemented in software, while others may be implemented with specific hardware devices. There may be one controller 47 for each switching unit 22 or a plurality of switching units 22 may share a single controller 47. Controller 47 may also be shared between one or more side A switching units 22 and one or more side B switching units 22′. Controller 47 may also be implemented by having one controller shared between all of the side A switching units 22 and another controller shared between all of the side B switching units 22′.

When a certain optical connection is required, as indicated for example, by externally generated connection information, controller 47 identifies a selected side A switching unit 22 and a selected side B switching unit 22′ to be optically connected. The connection information may originate, for example, within a network to which the switch is connected or from a master switch controller (not shown). Using the connection information, controller 47 generates a target position for an end 13 of selected side A fiber 12. The target position for the end 13 of selected side A fiber 12 is the position associated with the selected side B switching unit 22′ (i.e. the position required for selected side A fiber 12 to send optical communication signals to and/or to receive optical communication signals from selected side B switching unit 22′). Controller 47 uses this target position together with measured position information from position sensor 211 to generate control signals and to output these control signals to actuator 209. In response to these control signals, actuator 209 controllably moves the end 13 of selected side A fiber 12 in two dimensions, to the target position associated with selected side B switching unit 22′. When fiber end 13 is located at this target position associated with selected side B switching unit 22′, the selected side A switching unit 22 (or fiber 12) is optically aligned with the selected side B switching unit 22′. In a similar manner, actuator 209′ of the selected side B switching unit 22′ causes the end 13′ of selected side B fiber 12′ to move to its target position. The target position for the end 13′ of selected side B fiber 12′ is the position associated with selected side A switching unit 22 (i.e. the position required for the selected side B fiber 12′ to send optical communication signals to and/or to receive optical communication signals from the selected side A switching unit 22). When the end 13′ of selected side B fiber 12′ achieves this target position associated with selected side A switching unit 22, the selected side B switching unit 22′ is optically aligned with the selected side A switching unit 22.

In the illustrated embodiment, actuator 209 is a magnetic actuator, as described in co-owned PCT Patent Application No. PCT/CA02/00596. Additionally or alternatively, actuator 209 may comprise piezoelectric actuators, mechanical actuators, motorized actuators and micro-electromechanical (MEMs) actuators. The calibration apparatus and methods of this invention may generally be applied to switches incorporating any actuator 209 capable of moving the end of a fiber and/or any other suitable optical element.

In the illustrated embodiment, position sensor 211 comprises a two-dimensional “Moiré-type” encoder as described in co-owned PCT Patent Application No. PCT/CA02/00595 and PCT Patent Application No. PCT/CA02/00596, both of which are hereby incorporated by reference. The two-dimensional “Moiré-type” position sensor 211 of FIG. 4 is an example of a position sensor that may be used to implement this invention. Other types of position sensors could also be used. For example, each side A switching unit 22 may comprise inductive position sensors, capacitive position sensors, strain-based position sensors, magnetic position sensors, other types of optical position sensors, and/or any combination of these types of sensors. In other embodiments, or in certain switching units, position sensors 211 may not be required. In such embodiments, controller 47 may generate “open loop” control signals without direct position feedback.

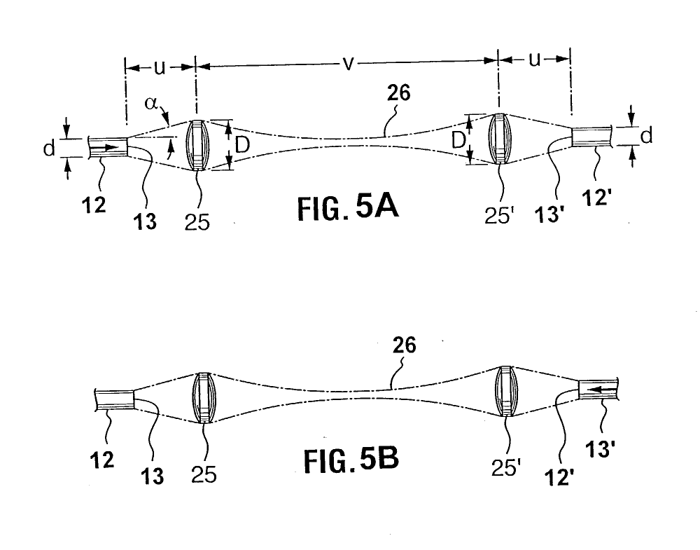

FIGS. 5A and 5B schematically depict the transmission of an optical communication signal across the switch interface. For clarity, some optional elements, such as bending mirrors, and other switching unit elements are omitted in FIGS. 5A and 5B. In order to reduce optical losses, it is preferable (but not necessary) that the communication signal be focused by lens 25 to form a beam 26, which has a “waist” in the switch interface cavity and which is directed substantially onto side B lens 25′. Focussing communication signal beam 26 in this manner helps to compensate for divergence of beam 26 and thereby achieve maximum optical throughput. Side B lens 25′ receives the communication signal beam 26 and couples it into the core of side B fiber 12′. In a similar manner, a communication signal beam 26 may be transmitted from side B fiber 12′ to side A fiber 12 as schematically depicted in FIG. 5B.

As discussed above, it is preferable that alignment control system 206 (see FIG. 1) is a “two-sided” control system that controls the alignment of the transmitting and receiving fibers on opposing sides of the switch. More specifically, if an optical communication signal is being transmitted from side A to side B, it is preferable that: (i) alignment control system 206 controls the position of the end 13 of a selected side A transmitting fiber 12 to optimize the transmission direction of communication signals to a selected side B receiving fiber 12′; and (ii) alignment control system 206 simultaneously controls the position of the end 13′ of the selected side B receiving fiber 12′ to optimize the reception of the communication signal from the selected side A transmitting fiber 12. Despite the advantages of using a two-sided alignment control system, the invention may be applied to OXC switches having “one-sided control”. For example, a switch having one-sided control may comprise stationary and uncontrolled signal receiving fibers on side B and may switch optical communication signals by controlling the position of side A transmitting fibers.

A calibration system 50 comprises a plurality of monitor channels 23 (see FIG. 3). Preferably (although not necessarily), calibration system 50 is a two-sided calibration system which includes a plurality of side A monitor channels 23 and a plurality of side B monitor channels 23′ (not shown in FIG. 3).

In the embodiment of FIG. 3, side A comprises four monitor channels 23A, 23B, 23C, 23D. The number of monitor channels 23 is different in other embodiments. There are preferably at least three monitor channels 23 on side A and at least three monitor channels 23′ on side B. Side A monitor channels 23 are spaced apart on side A chassis 16 and are not all collinear. Similarly, side B monitor channels 23′ are spaced apart on side B chassis 16′ and are not all collinear. In the embodiment illustrated in FIG. 3, each monitor channel 23 has the same dimensions as a switching unit 22, such that a monitor channel 23 may be inserted (in the place of any switching unit 22) into one of the 1×8 banks 17 of switching units 22 in chassis 16.

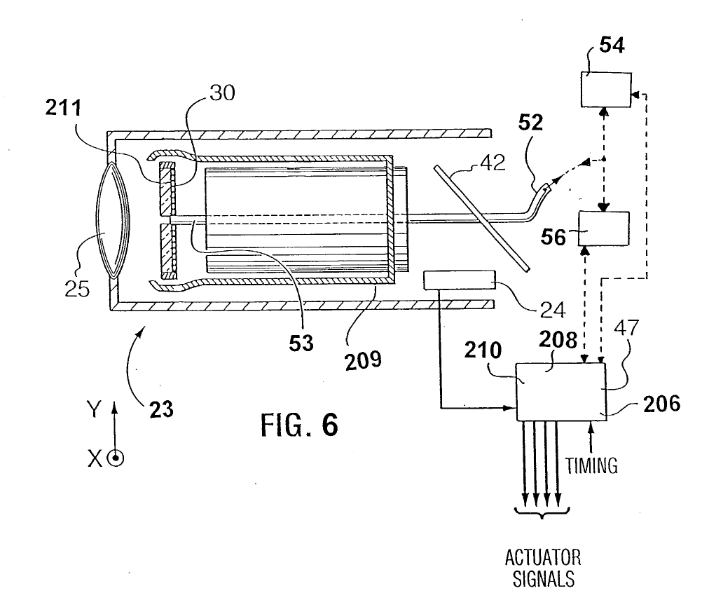

FIG. 6 depicts a particular embodiment of a side A monitor channel 23. Side B monitor channels 23′ may be substantially the same as monitor channel 23. Monitor channel 23 may be a switching unit 22 which is designated by controller 47 as a monitor channel. Monitor channel 23 includes:

lens 25, actuator 209, and position sensor 211, and is connected to position measurement system 210, actuation system 208, and alignment control system 206. In the illustrated embodiments, position measurement system 210, actuation system 208 and alignment control system 206 are provided by controller 47. Monitor channel 23 also comprises a fiber 52 having an end 53. Actuator 209 and position sensor 211 function in the same manner as actuator 209 and position sensor 211 of switching unit 22 (FIG. 4) to move and measure the position of the end 53 of monitor channel fiber 52. Monitor channel fiber 52 is coupled to both a radiation source 54 and a photodetector 56. Preferably, radiation source 54 and photodetector 56 are components of the OXC switch, but radiation source 54 and photodetector 56 may also be remotely located. Radiation source 54 may emit radiation that is of any suitable wavelength. The radiation emitted by radiation source 54 may be a constant intensity beam or a modulated beam.

For the purposes of describing various aspects of the of the invention, it is useful to define a number of terms:

(i) “local coordinate system” of a side A switching unit 22—“local coordinate system” of a side A monitor channel 23:

The local coordinate system of a particular side A switching unit 22 is the measurement space of the position sensor 211 corresponding to that particular switching unit 22 (see FIG. 4). Similarly, the local coordinate system of a particular side A monitor channel 23 is the measurement space of the position sensor 211 corresponding to that particular monitor channel 23 (see FIG. 6). For embodiments using different position sensors, the local coordinate system may have different representations. For example, such representations may vary because of the manner in which the position sensor outputs position information and/or the manner in which position transducer output is processed. Similar meanings may be applied in reference to the local coordinate system of a side B switching unit 22′ and to the local coordinate system of a side B monitor channel 23;

(ii) side A “global coordinate system”:

The coordinates associated with certain objects of interest may be stored in memory in a side A global coordinate system. Transformations back and forth between the side A global coordinate system and the local coordinate system of each individual side A switching unit 22 (and each individual side A monitor channel 23) may also be stored. Typically, the objects of interest to side A switching units 22 (or monitor channels 23) are side B switching units 22′ and side B monitor channels 23′. Consequently, the coordinates associated with side B switching units 22 and side B monitor channels 23 may be stored in the side A global coordinate system. Similarly, the coordinates associated with side A switching units 22 (and side A monitor channels 23) may be stored in a side B global coordinate system. Transformations back and forth between the side B global coordinate system and the local coordinate system of each individual side B switching unit 22′ (and each individual side B monitor channel 23′) may also be stored in memory;

(iii) location, position and/or coordinates “of” or “for” a side A fiber 12, 52, -location, position and/or coordinates “of” or “for” a side A fiber end 13, 53:

The location, position and/or coordinates of or for a side A fiber 12, 52 represent the actual position of the end 13, 53 of the side A fiber 12, 52 (as measured in the local coordinate system of the corresponding side A switching unit 22 or monitor channel 23). Similarly, the location, position and/or coordinates of or for a side A fiber end 13, 53 represent the actual position of the side A fiber end 13, 52 (as measured in the local coordinate system of the corresponding side A switching unit 22 or monitor channel 23). Similar meanings may be applied in reference to the location, position and/or coordinates of orfor a side B fiber 12′, 52′ or a side B fiber end 13′, 53′; and

(iv) location, position and/or coordinates “associated with” an object of interest:

The location, position and/or coordinates associated with an object of interest represent the coordinates at which the fiber end 13, 13′, 53, 53′ of a particular switching unit 22, 22′ (or monitor channel 23, 23′) must be, such that the particular switching unit 22, 22′ (or monitor channel 23, 23′) is configured to send and/or receive optical signals to/from the object of interest. The description may refer to the location, position and/or coordinates associated with an object in the local coordinate system of a certain switching unit 22, 22′ (or monitor channel 23, 23′). Typically, for side A switching units 22 (or side A monitor channels 23), the objects of interest are side B switching units 22′ (or side B monitor channels 23′). Thus, for example, the position associated with a side B switching unit 22′ of interest in the local coordinate system of a selected side A switching unit 22 represents the coordinates of the fiber end 13 of the selected side A switching unit 22 (as measured in the local coordinate system of the selected side A switching unit 22) when the selected side A switching unit 22 is configured to send and/or receive optical signals to/from the side B switching unit 22′ of interest. Similar meanings may be applied in reference to the location, position and/or coordinates associated with an object of interest in the local coordinate system of a selected side B switching unit 22′. The description may also refer to the location, position and/or coordinates associated with an object of interest in a global coordinate system. The global coordinates associated with an object of interest are transformable into local coordinates associated with the object of interest. For example, the position associated with an object of interest in a side A global coordinate system refers to the global coordinates, which, when transformed to a local coordinate system of a particular side A switching unit 22 (or monitor channel 23) represent the coordinates associated with the object of interest in the local coordinate system of that particular side A switching unit 22 (or monitor channel 23). Similar meanings may be applied in reference to the location, position and/or coordinates associated with an object of interest in the side B global coordinate system.

Any selected side A switching unit 22 may be configured to optically connect with any selected side B switching unit 22′ by:

(i) retrieving coordinates associated with the selected side B switching unit 22′ in the side A global coordinate system;

(ii) transforming these coordinates into the local coordinate system of the selected side A switching unit 22 to yield a target position; and,

(iii) moving fiber end 13 of the selected side A switching unit 22 to the target position.

The target position for the fiber end 13 of the selected side A switching unit 22 is the position associated with selected side B switching unit 22′ in the local coordinate system of side A switching unit 22. The selected side B switching unit 22′ is then configured in a similar manner to complete the optical connection between the selected side A switching unit 22 and the selected side B switching unit 22′.

This process may also be used to create optical connections between: (i) a selected side A monitor channel 23 and a selected side B monitor channel 23′; (ii) a selected side A monitor channel 23 and a selected side B switching unit 22′; and (iii) a selected side A switching unit 22 and a selected side B monitor channel 23′.

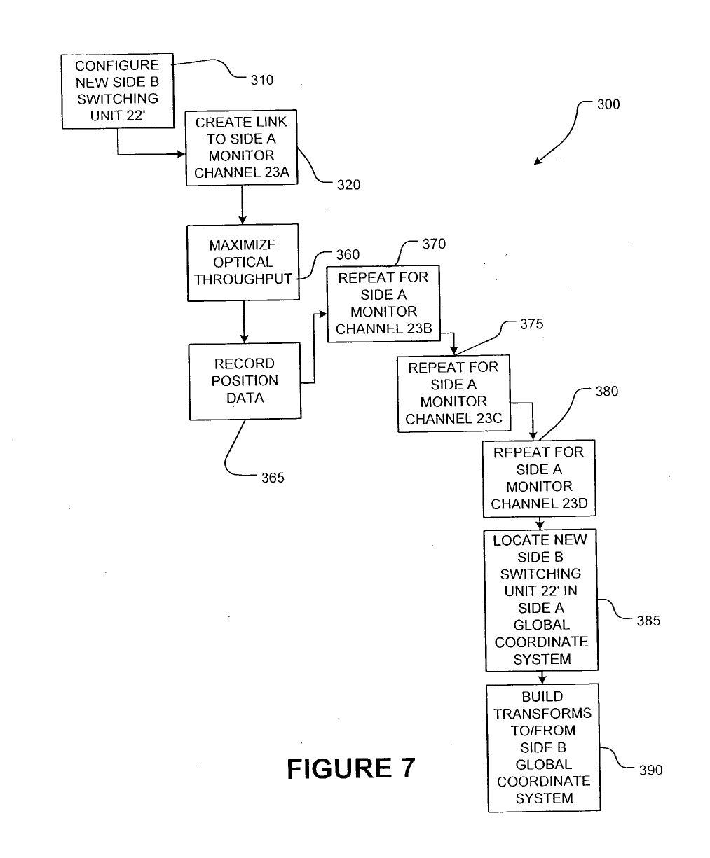

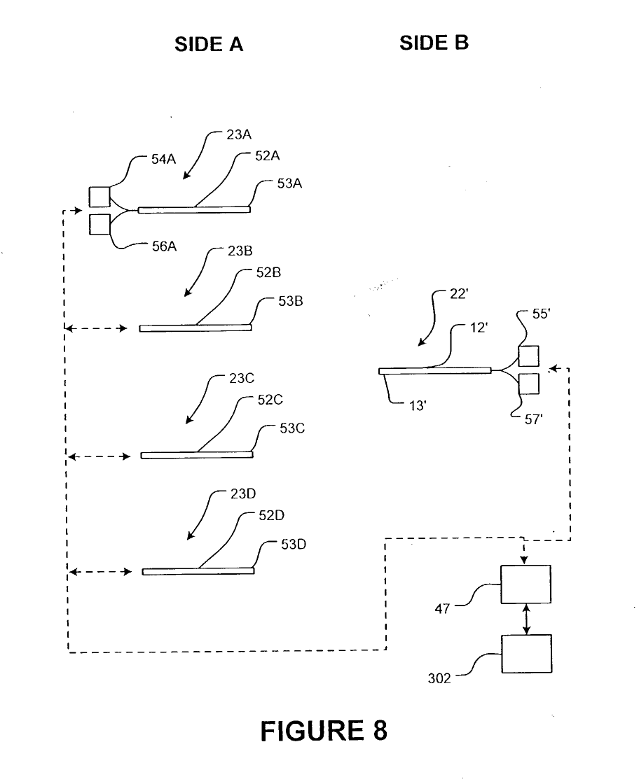

FIGS. 7 and 8 depict a method 300, according to a particular embodiment of the invention, for calibrating a new side B switching unit 22′ that has just been added to the switch. Calibration method 300 determines the position associated with the new side B switching unit 22′ in the side A global coordinate system and determines transformations back and forth between the local coordinate system of the new side B switching unit 22′ and the side B global coordinate system.

Calibration method 300 is performed by controller 47 which can access memory 302. Controller 47 is preferably connected, such that it can control and/or communicate with actuators 209, 209′ and position sensors 211, 211′ corresponding to each side A switching unit 22, each side B switching unit 22′, each side A monitor channel 23 and each side B monitor channel 23′. Preferably, controller 47 is also connected to enable control and/or communication with radiation sources 54, 54′ and photodetectors 56, 56′ corresponding to each side A monitor channel 23 and each side B monitor channel 23′. Controller 47 may also be connected such that it can control, communicate with and/or implement alignment control system 206, position measurement system 210 and actuation system 208 (see FIG. 1).

For the purposes of explaining calibration method 300, a number of simplifying assumptions are made. These assumptions are not essential to practising the invention. Method 300 assumes that:

(i) the positions associated with all of the side A switching units 22 (and side A monitor channels 23) are known in the side B global coordinate system;

(ii) the transformations back and forth between the side A global coordinate system and local coordinate system of each of the side A switching units 22 (and side A monitor channels 23) is known;

(iii) with the exception of the position associated with the new side B switching unit 22′, the positions associated with all of the other side B switching units 22′ (and side B monitor channels 23′) are known in the side A global coordinate system; and,

(iv) with the exception of the transformations back and forth between the side B global coordinate system and the new side B switching unit 22′, the transformations back and forth between the side B global coordinate system and the local coordinate system of each of the other side B switching units 22′ (and side B monitor channels 23′) is known.

This information may be stored in memory 302 and is available to controller 47 in this example.

In block 310, new side B switching unit 22′ is configured by connecting fiber 12 of side B switching unit 22′ to radiation source 55′ and radiation detector 57′ (see FIG. 8). Radiation source 55′ and radiation detector 57′ may be contained inside the OXC switch or, alternatively, may be remotely located. Connection of radiation source 55′ and radiation detector 57′ to new side B switching unit 22′ may involve temporarily disconnecting new side B switching unit 22′ from the network (not shown). If side B switching unit 22′ is disconnected from the network, then it is reconnected to the network at the conclusion of calibration method 300. Preferably, controller 47 is connected to enable control and/or communication with radiation source 55′ and radiation detector 57′.

In block 320, an optical connection is established between fiber 12′ of new side B switching unit 22′ and fiber 52A of side A monitor channel 23A. Based on known geometry of the OXC switch, controller 47 is aware of approximate nominal coordinates associated with new side B switching unit 22′ (and its fiber 12′) in the side A global coordinate system (i.e. approximate to within the mechanical geometrical tolerances of the switch layout). These approximate coordinates associated with new side B switching unit 22′ may be provided in memory 302 as nominal coordinates. Additionally or alternatively, approximate coordinates associated with new side B switching unit 22′ may be derived from the coordinates associated with a previous side B switching unit that was replaced by new side B switching unit 22′. Controller 47 also knows the transformation between the side A global coordinate system and the local coordinate system of side A monitor channel 23A (see above assumptions for method 300). Controller 47 transforms the approximate coordinates associated with the new side B switching unit 22′ from the side A global coordinate system to the local coordinate system of side A monitor channel 23A. This transformation yields an initial target position for fiber end 53A of side A monitor channel 23A. Controller 47 causes actuator 209 (see FIG. 6) to move fiber end 53A to this initial target position.

Controller 47 also determines an approximate position associated with side A monitor channel 23A (and its fiber 52A) in the local coordinate system of new side B switching unit 22′. This approximate position associated with side A monitor channel 23A may be derived from the known position associated with side A monitor channel 23A in the side B global coordinate system (see above assumptions for method 300) by using an approximation of the transformation between the side B global coordinate system and the local coordinate system of the new side B switching unit 22′.

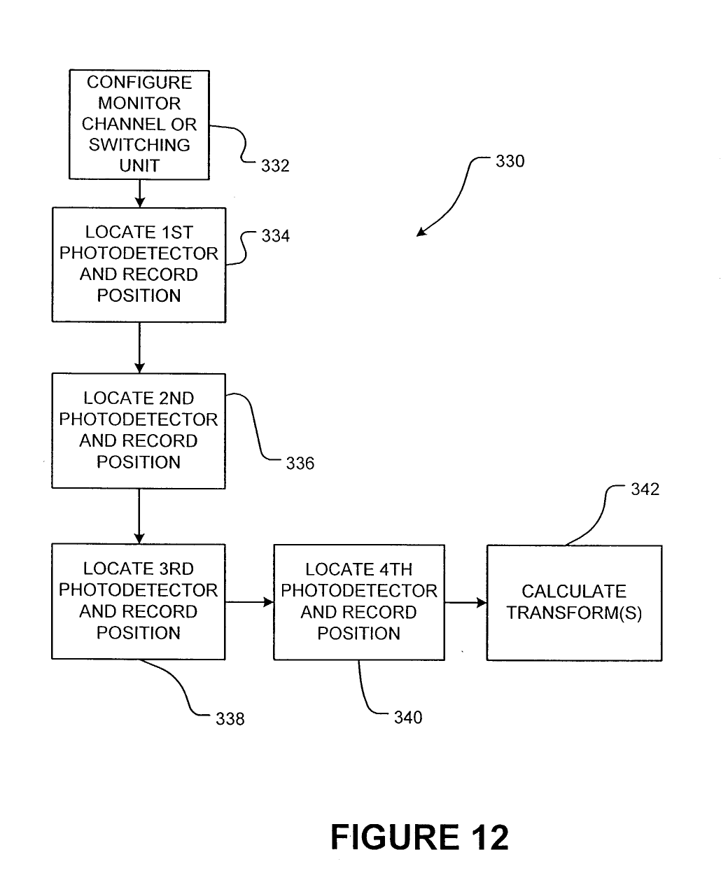

The approximation of the transformation between the side B global coordinate system and the local coordinate system of the new side B switching unit 22′ may be derived according to any of a number of techniques. For example, if there was a previous side B switching unit 22′, the approximate transformation may be based on a transformation corresponding to a previous side B switching unit 22′ that was previously calibrated and stored in memory 302. Additionally or alternatively, the approximate transformation may be obtained by assuming that the transformation corresponding to the new side B switching unit 22′ is a standard default transformation. Such standard default transformations may be stored in memory 302 and may be specific to particular switching units or may be common for a plurality of switching units. In preferred embodiments, however, controller 47 uses photodetectors 27 (FIG. 3) and method 330 (FIG. 12) to derive approximate transformations back and forth between the local coordinate system of new side B switching unit 22′ and the side B global coordinate system. Method 330 for deriving approximate transformations is discussed further below.

Use of any of these approximate transformations allows controller 47 to transform the known coordinates associated with side A monitor channel 23A in the side B global coordinate system to an initial target position associated with side A monitor channel 23A in the local coordinate system of new side B switching unit 22′. Controller 47 causes actuator 209′ to move fiber end 13′ to this initial target position.

When fiber end 53A (of side A monitor channel 23A) and fiber end 13′ (of new side B switching unit 22′) are in their initial target positions, radiation source 55′ emits a calibration signal that emerges from the end 13′ of fiber 12′. Controller 47 monitors the intensity of the calibration signal detected by photodetector 56A (see FIG. 8). Additionally or alternatively, a calibration signal may be emitted by radiation source 54A coupled to monitor channel fiber 52A and the intensity of the calibration signal may be measured by photodetector 57′ (see FIG. 8).

In block 360, controller 47 causes the ends 13′ and 53A of fibers 12′ and 52A to be scanned in a suitable search pattern until the optical throughput of the calibration signal(s) is maximized. Controller 47 may cause such scanning through control of actuator 209A of side A monitor channel 23A (see FIG. 6) and actuator 209′ of new side B switching unit 22′ (see FIG. 4).

Controller 47 moves fiber ends 13′ and 53A to maximize the optical throughput of the calibration signal. In a preferred embodiment, controller 47 causes fiber ends 13′ and/or 53A to move by small amounts while measuring and storing time-correlated samples of the resulting calibration signal optical throughput. Controller 47 may then calculate correlation(s) between the movements of the fiber ends 13′ and/or 53A and the calibration signal optical throughput over some time interval. Such correlation(s) enable controller 47 to determine which direction to move fiber end 13′ and/or fiber end 53A to improve the calibration signal optical throughput. For example, if fiber end 13′ moves in some arbitrary direction “x” and the correlation between the measured optical throughput and the movement in x direction indicates that increased optical throughput is achieved for small movements in the positive x direction, then the target position of fiber end 13′ should be adjusted in the positive x direction. This optical throughput maximization technique may be accomplished by actively moving fiber ends 13′ and/or 53A. Alternatively or additionally, the correlations may be derived from the unintentional oscillation of fiber ends 13′ and/or 53A caused by the servo-based alignment control system 206 (see FIG. 1).

Additionally or alternatively, maximization of the calibration signal optical throughput may also be achieved by having controller 47 cause fiber ends 13′ and 53A to be scanned in any of a wide variety of patterns until the optical throughput is maximized. For example, fiber end 13′ may be held still, while fiber end 53A is moved in a spiral manner. After optical throughput is maximized using this technique, fiber end 53A may be held still, while fiber end 13′ is moved in a spiral manner.

Once the optical throughput of the calibration signal(s) between new side B switching unit 22′ and side A monitor channel 23A is maximized, then controller 47 records position data in block 365. The position data comprises the coordinates of fiber end 13′ of new side B switching unit 22′, as detected by its position sensor 211′ (see FIG. 6). Since fiber end 13′ is aligned to optimize the connection with monitor channel 23A, these coordinates of fiber end 13′ represent the coordinates associated with side A monitor channel 23A in the local coordinate system of new side B switching unit 22′.

Controller 47 also records the coordinates of fiber end 53A of side A monitor channel 23 as detected by its position sensor 211 (see FIG. 6). Since fiber end 53A is aligned to optimize the connection with new side B switching unit 22′, these coordinates of fiber end 53A represent the coordinates associated with new side B switching unit 22′ in the local coordinate system of monitor channel 23A. Controller 47 uses a known transformation (see above assumptions) to transform the coordinates associated with new side B switching unit 22′ from the local coordinate system of side A monitor channel 23A to the side A global coordinate system. Controller 47 then records the coordinates associated with new side B switching unit 22′ in the side A global coordinate system.

At the completion of block 365, controller 47 has recorded: (i) coordinates associated with side A monitor channel 23A in the local coordinate system of new side B switching unit 22′; and (ii) coordinates associated with new side B switching unit 22′ in the side A global coordinate system.

In blocks 370, 375, 380 the procedures of blocks 320, 360, 365 are repeated for side A monitor channels 23B, 23C, 23D respectively. In each of blocks 370, 375 and 380, optical connections between the corresponding side A monitor channel and new side B switching unit 22′ are established, the optical throughput of the connection is maximized and position information is recorded. In blocks 370, 375, 380, controller 47 stores: (i) coordinates associated with side A monitor channels 23B, 23C, 23D in the local coordinate system of new side B switching unit 22′; and (ii) for each side A monitor channel 23B, 23C, 23D, a set of coordinates associated with side B switching unit 22′ in the side A global coordinate system.

In block 385, controller 47 uses the data recorded in blocks 365, 370, 375, 380 to compute a refined value for the coordinates associated with the new side B switching unit 22′ in the side A global coordinate system. In the illustrated embodiment of FIGS. 7 and 8, controller 47 uses coordinates associated with the new side B switching unit 22′ (as determined using each of monitor channels 23A, 23B, 23C, 23D in blocks 365, 370, 375, 380) to calculate the refined value for the coordinates associated with the new side B switching unit 22′ in the side A global coordinate system. The data (determined in blocks 365, 370, 375, 380) may be averaged or otherwise combined to obtain the refined coordinates associated with new side B switching unit 22′ in the side A global coordinate system.

In other embodiments (not shown), block 385 of calibration method 300 may involve measuring, recording and combining data from more than (or fewer than) four side A monitor channels to obtain the refined coordinates associated with the new side B switching unit 22′ in the side A global coordinate system. In still other embodiments, block 385 of calibration method 300 may be performed without averaging by selecting one of the measured positions associated with new side B switching unit 22′ in the side A global coordinate system. For example, block 385 may involve selecting the position measured by side A monitor channel 23B in block 370 to be the refined coordinates associated with new side B switching unit 22′ in the side A global coordinate system.

In block 385, controller 47 stores the refined coordinates associated with new side B switching unit 22′ in the side A global coordinate system into memory 302. At a later time, controller 47 may use this stored information to create an optical connection between any selected side A switching unit 22 (or any selected side A monitor channel 23) and new side B switching unit 22′.

In block 390, controller 47 uses the data recorded in blocks 365, 370, 375, 380 to compute a transformation between the local coordinate system of new side B switching unit 22′ and the side B global coordinate system. Controller 47 may determine this transformation using the measured positions associated with side A monitor channels 23A, 23B, 23C, 23D in the local coordinate system of new side B switching unit 22′ and the known positions associated with side A monitor channels 23A, 23B, 23C, 23D in the side B global coordinate system (see above assumptions for method 300).

In general, where the coordinate systems are two-dimensional, a transformation between the local coordinate system of new side B switching unit 22′ and the side B global coordinate system may have the following form:

$$\begin{matrix}[ \begin{matrix}\begin{matrix}X \\ Y\end{matrix} \\ 1\end{matrix} ] = T [ \begin{matrix}\begin{matrix}x \\ y\end{matrix} \\ 1\end{matrix} ] & ( 1 ) \\ where : \\ T = [ \begin{matrix}{s}_{x} & {r}_{x} & {x}_{o} \\ {r}_{y} & {s}_{y} & {y}_{o} \\ 0 & 0 & 1\end{matrix} ] & ( 2 )\end{matrix}$$

x, y are coordinates of a particular point in the local coordinate system of new side B switching unit 22′ defined in relation to unit vectors (\hat{x}, ŷ) that span the two-dimensional local coordinate system; and

X, Y are coordinates of the point (x, y) in the side B global coordinate system defined in relation to unit vectors (\hat{X},Ŷ) that span the two-dimensional side B global coordinate system.

Those skilled in the art will appreciate that the generic transformation of equation (1) may be used to transform a point (x, y) in the two-dimensional local coordinate system to a corresponding point (X, Y) in a two-dimensional global coordinate system.

The data measured and recorded in blocks 365, 370, 375, 380 include measured coordinates associated with the side A monitor channels 23A, 23B, 23C, 23D in the local coordinate system of new side B switching unit 22′. Each of these measured coordinates may be inserted into equation (1) as a point (x, y) in the two-dimensional local coordinate system of new side B switching unit 22′. The coordinates associated with the side A monitor channels 23A, 23B, 23C, 23D are known in the side B global coordinate system (see above assumptions for method 300). Each of these known coordinates may be inserted into equation (1) as a corresponding point (X, Y) in the side B global coordinate system. After making these substitutions into equation (1), controller 47 may solve a system of equations of the form of equation (1) to obtain x₀, y₀, sₓ, rₓ, s_{y}, r_{y} (i.e. the elements of the matrix T). It will be appreciated by those skilled in the art that, in accordance with equation (1), the elements of the matrix T determine a generalized transformation between the local coordinate system of new side B switching unit 22′ and the side B global coordinate system.

Since the elements of T represent six unknown quantities, controller 47 requires only the measurements corresponding to any three side A monitor channels (i.e. data recorded in any three of blocks 365, 370, 375, 380) to solve for the elements of the matrix T.

The illustrated embodiment of calibration method 300 involves measuring and recording the positions associated with four side A monitor channels 23A, 23B, 23C, 23D. The extra data acquired from extra monitor channels may be used to refine the transformation between the local coordinate system of new side B switching unit 22′ and the side B global coordinate system by performing various averaging techniques. For example, in the illustrated embodiment of calibration method 300, a separate transformation matrix T may be calculated for each of the four possible combinations of three monitor channels and then the individual elements of the transformation matrices T may be averaged over the four separately calculated transformations to determine a refined transformation matrix T. More sophisticated averaging techniques, such as least squares fitting may be used in suitable circumstances. In other embodiments (not shown), calibration method 300 may involve measuring and recording data from only three monitor channels (i.e. with no averaging) or from five or more monitor channels (i.e. with additional averaging).

As described above, controller 47 solves a system of equations which may be of the form of equation (1) to calculate a transformation that maps a point (x, y) in the local coordinate system of new side B switching unit 22′ to a point (X, Y) in the side B global coordinate system. In addition, as part of block 390, controller 47 calculates the inverse transformation, such that any point (X, Y) in the side B global coordinate system may be mapped to a point (x, y) in the local coordinate system of new side B switching unit 22′. As a part of block 390, controller 47 stores both of these transformations in memory 302. Since the positions associated with all of the side A switching units 22 and side A monitor channels 23 are known in the side B global coordinate system (see above assumptions for method 300), these two transformations may be used by controller 47 to align new side B switching unit 22′ with any side A switching unit 22 or any side A monitor channel 23.

Those skilled in the art will appreciate that it is advantageous to locate the side A monitor channels 23 so that they are not all collinear. When side A monitor channels 23A, 23B, 23C, 23D are non-collinear, there is information about two axes, which is necessary to calculate the transformations back and forth between the two-dimensional local coordinate system of new side B switching 22′ and the two-dimensional side B global coordinate system. It is also desirable that the above described averaging techniques of blocks 385 and 390 represent data taken from various spaced apart locations on side A of the switch. When side A monitor channels 23A, 23B, 23C, 23D are spaced apart, the position data captured as a part of blocks 365, 370, 375, 380 represents a wide range of positions for the fiber end 13′ of new side B switching unit 22′. In addition, when side A monitor channels 23A, 23B, 23C, 23D are spaced apart, any residual measurement error is likely to be a relatively small fraction of the separation between side A monitor channels 23A, 23B, 23C, 23D. Thus, the effect of any measurement error on the calibration of new side B switching unit 22′ is minimized.

Calibration method 300 may be performed on a new side B switching unit 22′ while other switching units 22, 22′ are being used to transmit and receive optical communication signals. In addition, some aspects of calibration method 300 may be performed for new side B switching unit 22′ at substantially the same time as aspects of calibration method 300 are being performed for other side A or side B switching units 22, 22′.

The illustrated embodiment of calibration method 300 is a special case where a single new side B switching unit 22′ is added to an otherwise calibrated OXC switch. Calibration methods according to the invention may be extended to cover other situations and to remove the assumptions discussed above. For example, where a plurality of new side B switching units 22′ is added to the OXC switch, calibration method 300 could be performed for each new side B switching unit 22′. Although the calibration of each new side B switching unit 22′ could occur sequentially, some aspects of the calibration of a new side B switching unit 22′ may overlap with aspects of the calibration of other new side B switching units 22′.

Those skilled in the art will appreciate that by using side B monitor channels 23A′, 23B′, 23C′ and 23D′, calibration method 300 may be applied to calibrate one or more new side A switching units 22 in substantially the same manner described above.

Calibration method 300 can thus be extended to calibrate a previously uncalibrated OXC switch by calibrating each side A switching unit 22 and calibrating each side B switching unit 22′. In this circumstance, there is no information available from previously calibrated switching units 22, 22′. Consequently, the approximate positions used to establish optical connections in blocks 320, 370, 375, 380 may be based on the known system geometry and may be provided in memory 302. The initial approximate transformations used to establish optical connections in blocks 320, 370, 375, 380 may make use of photodetectors 27 (FIG. 3) and method 330 (FIG. 12), as described further below.

Calibration method 300 can also be used where one or more new monitor channels are added to the switch. When calibrating a new monitor channel, controller 47 follows calibration method 300 except that a new monitor channel is used in place of new side B switching unit 22′. Method 300 may be performed to calibrate a new monitor channel 23, 23′ at any time during the operation of the OXC switch without interruption of the switching and/or signal transmission functions of the switch.

In order to establish an optical connection between a new switching unit 22, 22′ (or a new monitor channel 23, 23′) and an opposing monitor channel 23′, 23, an approximate transformation is required between the local coordinate system of the new switching unit 22, 22′ (or monitor channel 23, 23′) and its global coordinate system. For example, to establish an optical connection between new side B switching unit 22′ and any of the side A monitor channels 23 in blocks 320, 370, 375, 380 of method 300 (FIG. 7), an approximate transformation is required between the local coordinate system of new side B switching unit 22′ and the side B global coordinate system. Method 330 of FIG. 12 provides a general method for determining approximate transformations back and forth between the local coordinate system of any switching unit 22, 22′ (or any monitor channel 23, 23′) and its corresponding global coordinate system. For the purposes of explanation, it is assumed that method 330 is used to calculate an approximate transformation between a new side B switching unit 22′ and the side B global coordinate system.

Method 330 involves directing an optical calibration signal from side B switching unit 22′ towards each of a plurality of photodetectors 27 located on side A (see FIG. 3). Photodetectors 27 are responsive to light radiation incident over a wider range of angles than are switching units 22. Preferably, as shown in FIG. 3, side A photodetectors 27 are located at non-collinear spaced apart locations amongst the side A switching units 22 and monitor channels 23. Controller 47 has access to nominal coordinates associated with each side A photodetector 27. These nominal coordinates may be provided in memory 302. Preferably, these nominal coordinates associated with side A photodetectors 27 are based on the known switch geometry and, therefore, are related to the nominal coordinates associated with the side A monitor channels 23. Preferably, these nominal coordinates associated with side A photodetectors 27 are coordinates which may be expressed in the side B global coordinate system.

In block 332, side B switching unit 22′ is configured by connecting it to a radiation source 55′ and a radiation detector 57′ (see FIG. 8, for example). As with calibration method 300, radiation source 55′ and detector 57′ may be connected temporarily for the purpose of performing method 330 and may involve temporary disconnection of switching unit 22′ from the network (not shown). Radiation source 55′ and detector 57′ may be located within the OXC switch or may be remotely located. Preferably, controller 47 is connected to enable control and/or communication with radiation source 55′ and radiation detector 57′. When method 330 is being performed on a monitor channel 23, 23′, there may already be a connection to a radiation source 54, 54′ and detector 56, 56′ (see FIG. 6).

In block 334, controller 47 causes fiber 12′ of side B switching unit 22′ to emit radiation and controller 47 attempts to direct this radiation at a first side A photodetector 27A. Establishing an optical connection between side B switching unit 22′ and first photodetector 27A may involve moving the end 13′ of fiber 12′ corresponding to side B monitor channel 22′ in a search pattern. Many search patterns are possible. For example, the end 13′ of fiber 12′ corresponding to side B monitor channel 22′ may be moved in spiral pattern until radiation from fiber 12′ is received at first photodetector 27A. Once an optical connection with photodetector 27A is established, it may be optimized by continuing to move the end 13′ of fiber 12′ until the radiation detected by first photodetector 27A is maximized. The search required to establish and maximize the throughput of an optical connection with a photodetector 27 is generally easier than establishing a connection with another optical fiber, because a photodetector generally accepts radiation from wider angles of incidence and the orientation of a photodetector need not normally be adjusted to accept radiation.

When the optical throughput between side B switching unit 22′ and first photodetector 27A is maximized, controller 47 records the coordinates of fiber end 13′ of new side B switching unit 22′ as detected by its position sensor 211′ (see FIG. 6). Since fiber end 13′ is aligned to maximize the connection with first photodetector 27A, these coordinates are the coordinates associated with first photodetector 27A in the local coordinate system of side B switching unit 22′.

In blocks 336, 338, 340, controller 47 repeats the procedure of block 334 for second, third and fourth photodetectors 27B, 27C, 27D. In each of blocks 336, 338, 340 controller 47 establishes and maximizes optical connections between side B switching unit 22′ and the corresponding photodetector 27 and records position information. In blocks 336, 338, 340, controller 47 stores the coordinates associated with photodetectors 27B, 27C, 27D in the local coordinate system of side B switching unit 22′.

In block 342, controller 47 uses the coordinates recorded in blocks 334, 336, 338, 340 along with the nominal coordinates associated with photodetectors 27 to compute approximate transformations back and forth between the local coordinate system of side B switching unit 22′ and the side B global coordinate system. The calculation of the approximate transformation in block 342 is similar to the procedure used in block 390 of calibration method 300 discussed above. Equation (1) may be used to derive the elements of an approximate transformation matrix T.

Each of the sets of coordinates measured in blocks 334, 336, 338, 340 represents a measured position associated with a photodetector 27 in the local coordinate system of side B switching unit 22′. Each of these sets of coordinates may be inserted into equation (1) as a point (x, y). Similarly, each of the nominal coordinates associated with photodetectors 27 may be inserted into equation (1) as a corresponding point (X, Y) in the side B global coordinate system. After making these substitutions, controller 47 may solve a system of equations of the form of equation (1) to determine the elements of the approximate transformation matrix T.

Since the elements of T represent six unknown quantities, controller 47 requires only the measurements corresponding to three photodetectors 27 to solve the system of equations. Extra data obtained from fourth photodetector 27D (or any additional photodetectors (not shown)) may be incorporated to refine the calculation of the approximate transformation matrix T using various averaging techniques. Such averaging techniques may be similar to those discussed above in block 390 of calibration method 300. In other embodiments, method 330 of the present invention may use only three photodetectors 27 (i.e. with no averaging). The approximate transformation matrix T calculated in block 342 maps a point in the local coordinate system of side B switching unit 22′ to a point in the side B global coordinate system. In block 342, controller 47 may also calculate an approximate inverse transformation that maps any point in the side B global coordinate system to the local coordinate system of side B switching unit 22′.

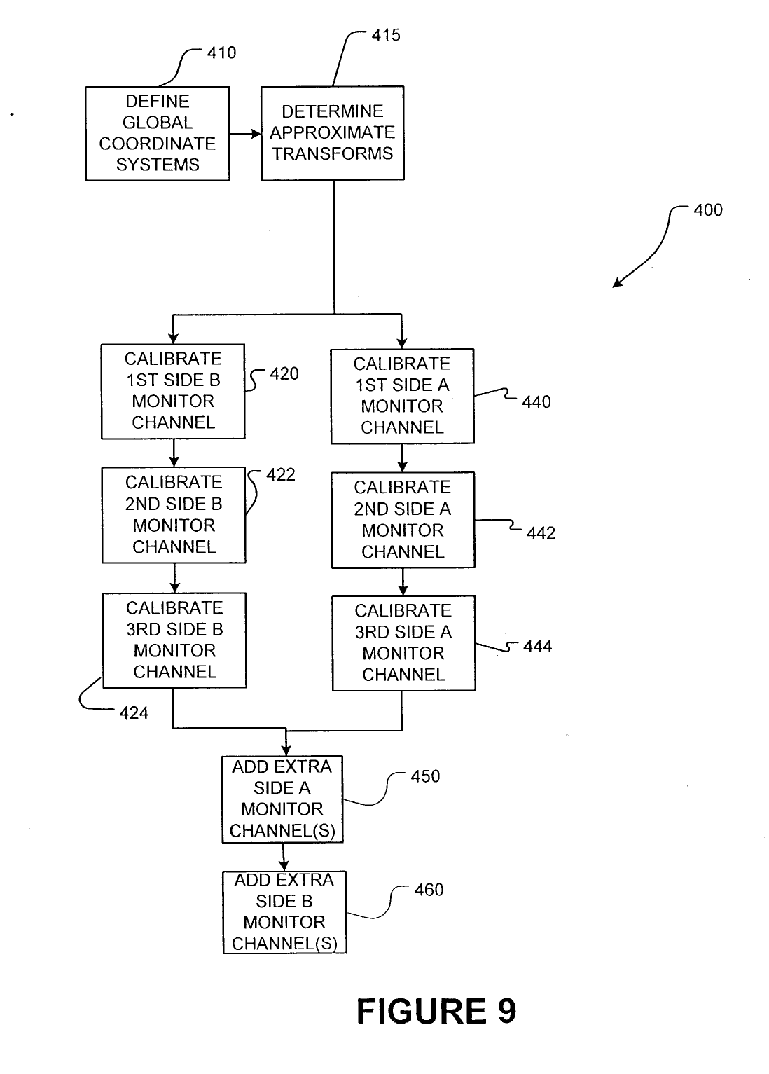

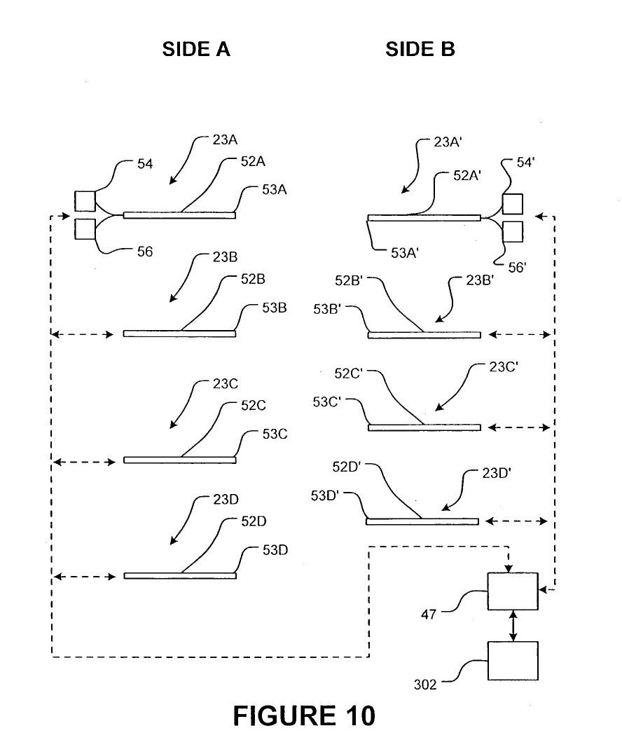

FIGS. 9 and 10 depict an initialization method 400 for initializing an OXC switch in accordance with one embodiment of the invention. Initialization method 400 may be performed to determine:

(i) the positions associated with all of the side A monitor channels 23 in the side B global coordinate system;

(ii) the transformations back and forth between the local coordinate system of each of the side A monitor channels 23 and the side A global coordinate system;

(iii) the positions associated with all of the side B monitor channels 23′ in the side A global coordinate system; and,

(iv) the transformations back and forth between the local coordinate system of each of the side B monitor channels 23′ and the side B global coordinate system.

Initialization method 400 yields sufficient information to execute calibration method 300. Thus, initialization method 400 may be performed on a previously uncalibrated switch, such that, subsequently, controller 47 may calibrate side A and B switching units 22, 22′ according to calibration method 300.

Initialization method 400 may be performed by controller 47. Controller 47 has access to nominal coordinates associated with at least three side A monitor channels 23A, 23B, 23C. These nominal coordinates may be provided in memory 302 and may be based on the known geometry of the OXC switch. Similarly, controller 47 has access to nominal coordinates associated with at least three side B monitor channels 23A′, 23B′, 23C′ which may also be provided in memory 302 and may also be based on the known geometry of the OXC switch. These nominal coordinates may differ from switch to switch depending on the geometry of the particular switch.

In block 410, controller 47 defines the side A and side B global coordinate systems. Preferably, controller 47 defines the side A global coordinate system based on the nominal coordinates associated with three side B monitor channels 23A′, 23B′, 23C′. In particular embodiments, controller 47 defines the side A global coordinate system by assigning the nominal coordinates associated with the three side B monitor channels 23A′, 23B′, 23C′ to be the side A global coordinates associated with the side B monitor channels 23A′, 23B′, 23C′. Controller 47 may use similar techniques to define the side B global coordinate system based on the nominal coordinates associated with three side A monitor channels 23A, 23B, 23C.

In block 415, controller 47 may perform transformation approximation method 330 (FIG. 12) to determine approximate transformations. Controller 47 executes transformation approximation method 330 for each of the three side A monitor channels 23A, 23B, 23C to determine approximate transformations back and forth between the local coordinate systems of each of side A monitor channels 23A, 23B, 23C and the newly defined side A global coordinate system. Similarly, controller 47 executes transformation approximation method 330 for each of the three side B monitor channels 23A′, 23B′, 23C′ to determine approximate transformations back and forth between the local coordinate systems of each of side B monitor channels 23A′, 23B′, 23C′ and the newly defined side B global coordinate system. As discussed further below these approximate transformations may be used by controller 47 to establish initial optical connections between side A and side B monitor channels 23, 23′.

Blocks 420, 422, 424 of initialization method 400 involve calibrating the three side B monitor channels 23A′, 23B′, 23C′. As part of blocks 420, 422, 424 controller 47 replaces the approximate side B transformations (determined in block 415) with refined transformations for the three side B monitor channels 23A′, 23B′, 23C′.

In block 420, a first side B monitor channel 23A′ is calibrated to the newly defined side B global coordinate system. Controller 47 performs the calibration of first side B monitor channel 23A′ by sequentially:

(i) establishing an initial optical connection between first side B monitor channel 23A′ and each of the three side A monitor channels 23A, 23B, 23C;

(ii) maximizing the optical throughput between first side B monitor channel 23A′ and each of side A monitor channels 23A, 23B, 23C; and,

(iii) recording coordinates associated with each of side A monitor channels 23A, 23B, 23C in the local coordinate system of first side B monitor channel 23A′.

To establish the initial optical connections, controller 47 may use the nominal coordinates associated with first side B monitor channel 23A′ and side A monitor channels 23A, 23B, 23C together with the approximate transformations determined in block 415. For example, to establish an optical connection between first side B monitor channel 23A′ and a particular side A monitor channel 23C, controller 47 may:

(i) use the approximate transformation between the side A global coordinate system and the local coordinate system of the particular side A monitor channel 23C to transform the nominal coordinates associated with first side B monitor channel 23A′ from the side A global coordinate system to the local coordinate system of the particular side A monitor channel 23C. This transformation determines a target position for the fiber end 53C of the particular side A monitor channel 23C, wherein the target position represents an approximate position associated with first side B monitor channel 23A′ in the local coordinate system of the particular side A monitor channel 23C;

(ii) move the fiber end 53C of the particular side A monitor channel 23C to its target position by controlling its actuator 209C (see FIG. 6); and

(iii) perform a similar transformation to obtain a target position for the fiber end 53A′ of first side B monitor channel 23A′ (i.e. an approximate position associated with the particular side A monitor channel 23C in the local coordinate system of first side B monitor channel 23A′) and move the fiber end 53A′ of first side B monitor channel 23A′ to its target position by controlling its actuator 209A′.

Maximizing the optical throughput of each optical connection and recording coordinates associated with each of side A monitor channels 23A, 23B, 23C in the local coordinate system of first side B monitor channel 23A′ may be performed in a manner substantially similar to that of calibration method 300 described above.

At the conclusion of block 420, controller 47 determines a transformation between the local coordinate system of first side B monitor channel 23A′ and the newly defined side B global coordinate system. Controller 47 may determine this transformation in a manner that is similar to the transformation calculation in block 390 of calibration method 300. Controller 47 also determines an inverse transformation, such that a point in the side B global coordinate system may be mapped to the local coordinate system of first side B monitor channel 23A′. These refined transformations (determined in block 420) replace the approximate transformations (determined in block 415) for first side B monitor channel 23A′. The transformations back and forth between the local coordinate system of first side B monitor channel 23A′ and the side B global coordinate system may be used to align first side B monitor channel 23A′ with any device having known coordinates in the side B global coordinate system.

In block 422 and block 424, controller 47 respectively calibrates a second side B monitor channel 23B′ and a third side B monitor channel 23C′ to the newly defined side B global coordinate system. These processes may be substantially similar to the process of calibrating first side B monitor channel 23A′ in block 420. In blocks 422, 424, controller 47 determines transformations back and forth between the local coordinate systems of side B monitor channels 23B′ and 23C′ and the newly defined side B global coordinate system. These transformations replace the approximate transformations for side B monitor channels 23B′ and 23C′ that were determined in block 415.

At the conclusion of block 424, controller 47 has defined a side B global coordinate system and calibrated three side B monitor channels 23A′, 23B′, 23C′, such that a point in the side B global coordinate system may be mapped to the local coordinate systems of the three side B monitor channels 23A′, 23B′, 23C′ and a point in the local coordinate systems of the three side B monitor channels 23A′, 23B′, 23C′ may be mapped to the side B global coordinate system.

Blocks 440, 442, 444 of initialization method 400 (which may be executed concurrently with blocks 420, 422, 424) involve determining transformations back and forth between the local coordinate systems of three side A monitor channels 23A, 23B, 23C and the side A global coordinate system. The processes involved in blocks 440, 442, 444 to calibrate the side A monitor channels 23A, 23B, 23C are substantially similar to the processes involved in blocks 420, 422, 424 to calibrate the side B monitor channels 23A′, 23B′, 23C′.

At the conclusion of block 444, controller 47 has defined a side A global coordinate system and calibrated three side A monitor channels 23A, 23B, 23C by determining transformations back and forth between the side A global coordinate system and the local coordinate systems of each of the side A monitor channels 23A, 23B, 23C. Using these transformations, a point in the side A global coordinate system may be mapped to the local coordinate systems of the three side A monitor channels 23A, 23B, 23C and a point in the local coordinate systems of any of the three side A monitor channels 23A, 23B, 23C may be mapped to the side A global coordinate system.

As shown in FIGS. 9 and 10, the illustrated embodiment of initialization method 400 contemplates that each side of the OXC switch comprises four monitor channels (for example, side A monitor channels 23A, 23B, 23C, 23D). As discussed above, only three monitor channels from each side are required to define a global coordinate system and to obtain transformations. Any additional side A and B monitor channels (such as monitor channels 23D, 23D′) may be added and calibrated according to calibration method 300. It is preferable to calibrate extra monitor channels 23D, 23D′ prior to the calibration of switching units 22, 22′, because extra monitor channels 23D, 23D′ may be used to achieve improved calibration in method 300 by averaging, as described above.

In block 450, controller 47 calibrates the extra side A monitor channel 23D according to calibration method 300. Similarly, in block 460, controller 47 calibrates the extra side B monitor channel 23D′.

Another aspect of the present invention involves updating the OXC switch calibration information from time to time. Updating the calibration information (or, recalibrating) may be used to help overcome drift or deviation of the electrical, mechanical or optical characteristics of switch components.

In normal operation, switching units 22, 22′ are used to transmit and/or receive optical communication signals. There may be periods during which particular switching units 22, 22′ are not being used for transmitting, receiving or switching optical communication signals. In these circumstances, controller 47 may recalibrate any inactive switching units 22, 22′ in accordance with calibration method 300. Such recalibration enables controller 47 to update the calibration information relating to that particular switching unit 22, 22′.

In practice, after the initialization (for example, by initialization method 400) and calibration (for example, by calibration method 300), many switching units 22, 22′ will be in use to transmit, receive and/or switch optical communication signals. Consequently, these switching units 22, 22′ will not be available to be recalibrated according to calibration method 300. Recalibration may also be performed from time to time using monitor channels 23, 23′.

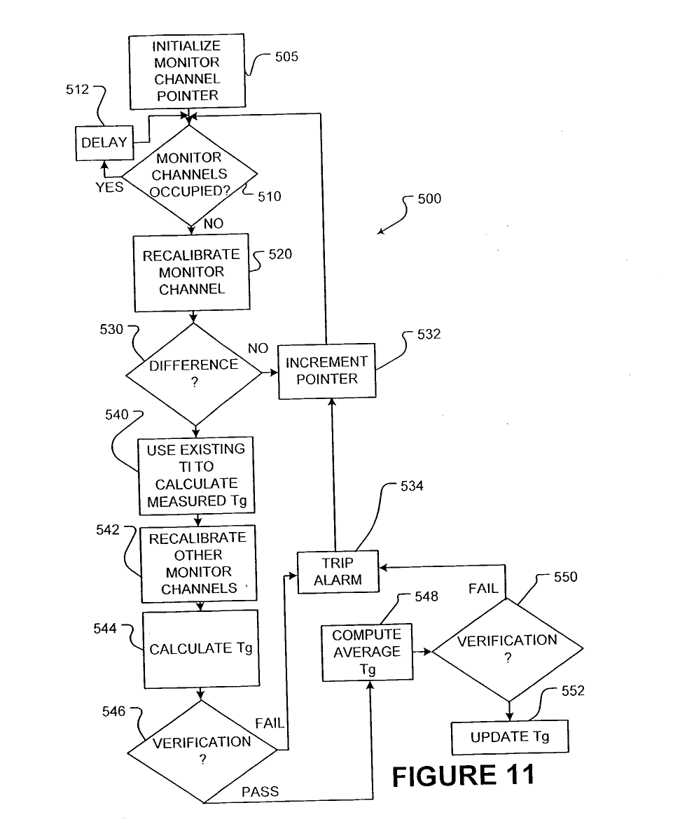

FIG. 11 shows a method 500 for the recalibration of an OXC switch according to a particular embodiment of the invention. Recalibration method 500 involves recalibrating the transformations between the local coordinate system of switching units 22, 22′ and the side A and B global coordinate systems. Recalibration method 500 may be performed by controller 47. Controller 47 may be the same controller that controls calibration method 300, transformation approximation method 330, and/or initialization method 400.

In recalibration method 500, controller 47 models each transformation matrix T of equation (1) as:

T=TₗT_{g} (3)

where: Tₗ is a component of T that is specific to each particular switching unit 22, 22′; and T_{g} is a global component of T that is common to all of the switching units 22, 22′ on a particular side of the switch. Recalibration method 500 involves updating the global component T_{g} for all of the transformation matrices T corresponding to switching units 22, 22′ on a particular side of the switch.

During initial calibration described above in calibration method 300 and initialization method 400 (i.e. prior to the execution of recalibration method 500), the global component T_{g} of equation (3) may set to some default value, conveniently unity. Where the global component T_{g} defaults to unity, the local transformation matrix Tₗ for each switching unit 22, 22′ is equal to the combined transformation matrix T. However, when T_{g} is not unity (i.e. after the execution of recalibration method 500), then calibration method 300 and initialization method 400 may involve the determination and storage of Tₗ (rather than storage of T itself). Consequently, when controller 47 needs to calculate a transformation (e.g. to create an optical connection between switching units 22, 22′ on opposing sides of the switch), it uses the retained values of Tₗ for each switching unit 22, 22′ (as determined in calibration method 300) and the current value of T_{g} for each side of the switch (as determined in method 500) to calculate T for each switching unit 22, 22′ according to equation (3). Similarly, when controller 47 needs to calculate a transformation (e.g. to create an optical connection involving a monitor channel 23, 23′), it uses the retained value of Tₗ for that monitor channel 23, 23′ (as determined in initialization method 400) and the current value of T_{g} (for that side of the switch) to calculate a transformation T according to equation (3). Consequently, when the global component T_{g} of equation (3) is updated as a part of recalibration method 500, it affects the resultant transformations for all of the switching units 22, 22′ and monitor channels 23, 23′ on its particular side of the switch.

Preferably, calibration method 500 is performed after all of the monitor channels 23, 23′ and switching units 22, 22′ of interest have been calibrated. Recalibration method 500 starts in block 505, where a monitor channel pointer is initialized to point at a first monitor channel. In the example described below, the monitor channel pointer points to side A monitor channel 23A. The monitor channel pointer is preferably changed to point to a different monitor channel each time recalibration method 500 is executed. Over a number of repetitions of method 500, the monitor channel pointer cycles through a set of monitor channels.

In block 510, controller 47 polls the switch to determine whether monitor channels 23, 23′ are occupied or unoccupied. If monitor channels 23, 23′ are occupied, then a delay occurs for a period of time in block 512, before controller 47 queries again as to whether monitor channels 23, 23′ are occupied. When monitor channels 23, 23′ are avaliable, controller 47 proceeds to block 520.

In block 520, the monitor channel 23, 23′ which is identified by the monitor channel pointer is recalibrated according to calibration method 300. In this example, the monitor channel pointer identifies monitor channel 23A. Consequently, monitor channel 23A is recalibrated in block 520. Recalibration in block 520 may be similar to calibration method 300. In block 520, controller 47 sequentially:

(i) creates an optical connection between side A monitor channel 23A and each of a plurality of side B monitor channels 23A′, 23B′, 23C′, 23D′;

(ii) maximizes the optical throughput for each of monitor channels 23A′, 23B′, 23C′, 23D′; and,

(iii) records position information related to the optical connections between side A monitor channel 23A and each of side B monitor channels 23A′, 23B′, 23C′, 23D′.

In accordance with calibration method 300, the recalibration procedure of block 520 yields a set of calibration parameters, which include: a new set of coordinates associated with side A monitor channel 23A in the side B global coordinate system; and a newly derived transformation matrix T between the local coordinate system of side A monitor channel 23A and the side A global coordinate system.

In block 530, controller 47 compares one or more of the newly determined calibration parameters to the corresponding previously stored values of the calibration parameters. Any differences may result from drift in electrical, mechanical or optical properties of the switch components. In some circumstances, there will be no significant change in the calibration parameters. In such cases, controller 47 changes the value of the monitor channel pointer in block 532 and loops back to block 510. It is preferable, but not necessary, that the monitor channel pointer alternates between side A monitor channels 23 and side B monitor channels 23′ on successive iterations of block 532.

If the newly measured calibration parameters are sufficiently different from the previously stored values of the calibration parameters, then controller 47 proceeds to block 540. In block 540, controller 47 determines a new side A global component T_{g} based upon the newly measured calibration parameters. This may be done according to equation (3). Controller 47 calculates the new side A global component T_{g} using the previously stored value of Tₗ for monitor channel 23A (i.e. the value of Tₗ determined and stored prior to the current execution of recalibration method 500) and the transformation matrix T newly determined in block 520.

In block 542, controller 47 recalibrates the other monitor channels 23, 23′ that are on the same side of the switch as the monitor channel indicated by the monitor channel pointer. Recalibration of each such monitor channel 23, 23′ is substantially similar to calibration method 300. For the purpose of describing recalibration method 500, it is assumed that the monitor channel pointer points at side A monitor channel 23A. Consequently, block 542 involves the recalibration of the other side A monitor channels 23B, 23C, 23D. For each of these side A monitor channels 23B, 23C, 23D, controller 47 determines a set of calibration parameters which include: newly determined transformations back and forth between the local coordinate systems of the particular side A monitor channel 23B, 23C, 23D and the side A global coordinate system.

In block 544, controller 47 calculates a new representation of global component T_{g}. This calculation may be similar to that described above (block 540), but is based upon the newly determined calibration parameters (block 542) for each of the other monitor channels 23, 23′ that are on the same side as the monitor channel indicated by the monitor channel pointer. Where the monitor channel pointer is pointing at monitor channel 23A, in block 544, controller 47 calculates a new representation of global component T_{g} based upon the calibration parameters obtained for each of side A monitor channels 23B, 23C, 23D.

Block 544 (together with block 540) yields a set of newly determined global components T_{g}, each of which is based upon the calibration parameters for one side A monitor channel 23. In block 546, controller 47 performs one or more verification procedures on the set of newly determined side A global components T_{g} to determine whether the previously stored value of side A global component T_{g} should be changed. Such verification procedures may be generally designed to determine if there is an anomaly in one of the monitor channels 23, 23′.

Such verification procedures may comprise, for example, a comparison of the members of the set of newly determined side A global components T_{g}. If controller 47 finds that three of the four newly determined T_{g} values are substantially similar, but that one of the newly determined T_{g} values differs from the others by more than a threshold amount, then controller 47 may determine that one of the monitor channels 23, 23′ should be replaced, rather than modifying the previously stored value of side A global component T_{g}. As a further example of a verification technique, controller 47 may determine the magnitudes of differences between the four newly determined representations of T_{g} and the previously stored value of side A global component T_{g}. If one or more of the newly determined global components T_{g} differs from the previously stored value of side A global component T_{g} by more than a small amount, then the discrepancy between the newly determined representations of side A global component T_{g} and the previously stored value of side A global component T_{g} may have been caused by something other than simple drift. For example, one of the monitor channels 23, 23′ may require replacement, rather than changing the previously stored value of side A global component T_{g}.

Although two examples of verification are explained above, it should be understood by those skilled in the art that other verification schemes could be used as a part of block 544 to determine whether the previously stored value of side A global component T_{g} should be changed.

If the verification procedures of block 546 fail, then controller 47 proceeds to block 534, where it sets a failed verification flag, and block 532, where it changes the monitor channel pointer, before looping back to block 510. The failed verification flag set in block 534 may cause an alarm signal or message to be generated which indicates that service to the switch is required.

If the newly determined set of side A global components T_{g} passes the verification procedures of block 546, then in block 548, controller 47 obtains a new value for T_{g} based upon the set of newly determined T_{g} values. This new value of T_{g} may be obtained, for example, by: simple averaging, weighted averaging, filtering with historical values of T_{g}, selecting one from among the newly determined T_{g} and numerical fitting techniques using the set of newly determined side A global components T_{g}.

Controller 47 may undertake additional verification steps in block 550 (using the new value of T_{g} determined in block 548) to decide whether the previously stored value of side A global component T_{g} should be changed. Such verification procedures may comprise, for example, controller 47 comparing the magnitude of the differences between the previously stored value of side A global component T_{g} and the new value of T_{g} determined in block 548. If the magnitude of the differences is above a certain level, then controller 47 may decide that such changes are not due to drift and that some other problem must have occurred. Such verification procedures may also include, for example, testing the new value of T_{g} determined in block 548 using the monitor channels 23, 23′ to verify that acceptable optical connections may be made between all of the possible monitor channels 23, 23′ prior to updating the previously stored value of side A global component T_{g}.

If the new value of T_{g} determined in block 548 fails the verification procedures of block 550, then controller 47 proceeds to block 534, where it sets a failed verification flag, and block 532, where it changes the monitor channel pointer, before looping back to block 510. The failed verification flag set in block 534 may indicate, for example, that service to the switch is required. Those skilled in the art will appreciate that there are a wide variety of verification schemes that could be used as a part of block 550.

If the new value of T_{g} passes the verification procedures of block 550, then controller 47 replaces the previously stored value of side A global component T_{g} with the new value of T_{g} determined in block 548. The new T_{g} is stored in memory 302 and, in accordance with equation (3), the new T_{g} is used to update the transformations and optical connections for all of the side A monitor channels 23 and switching units 22. Because changes in T_{g} should be relatively small in order to pass the verification procedures of blocks 546 and 550, the changes in T_{g} should not have a dramatic impact on the existing optical connections between various switching units 22, 22′. Accordingly, recalibration method 500 may be performed while switching units 22, 22′ are engaged in transmitting, receiving and switching communication signals.

For example, if a new side A switching unit 22 is added to the OXC switch and is calibrated according to method 300, then controller 47 determines the transformations back and forth between the local coordinate system of that particular side A switching unit 22 and the side A global coordinate system. Part of this transformation includes a measured value for a transformation matrix T (see equation (1)). Controller 47 then uses the updated value of T_{g} along with the measured value of the transformation matrix T to determine a local component Tₗ according to equation (3). This local component Tₗ of the transformation matrix T is stored in memory 302 and corresponds to that particular side A switching unit 22.

The newly updated value of T_{g} is also used by the previously calibrated side A switching units 22 and side A monitor channels 23. As discussed above, the transformation parameters actually stored during calibration method 300 and initialization method 400 are the local components Tₗ of equation (3). For example, when a particular side A switching unit 22 is required to be optically connected with a side B switching unit 22′, then the local component Tₗ and the global component T_{g} are inserted into equation (3) to obtain the transformation matrix T. The transformation matrix T is then inserted into equation (1) to obtain the position associated with side B switching unit 22′ in the local coordinate system of the particular side A switching unit 22. In a similar manner, controller 47 updates the position associated with the side B switching units 22′ (or monitor channels 23′) to which all side A switching units 22 (and monitor channels 23) are optically connected in the respective local coordinate systems. Thus, when the side A global component T_{g} is updated, it affects the transformations and optical connections for each of the side A switching units 22 and each of the side A monitor channels 23.

In some embodiments, controller 47 may use a subset of the plurality of monitor channels 23, 23′ on each side of the switch in recalibration method 500. For example, controller 47 may use only two side A monitor channels 23A and 23C in method 500. In a further alternative example, controller 47 uses only a single monitor channel (i.e. the monitor channel indicated by the monitor channel pointer) to perform recalibration method 500. Implementing method 500 with a reduced number of monitor channels 23, 23′ may involve a reduction in accuracy when compared to implementing method 500 by averaging over a relatively large number of monitor channels 23, 23′. However, using a reduced number of monitor channels 23, 23′ has the advantages of requiring less processing resources from controller 47 and leaving some monitor channel(s) 23, 23′ free to perform other tasks.

The above description of recalibration method 500 is explained with the monitor channel pointer pointing at side A monitor channel 23A. It will be appreciated by those skilled in the art that the procedures are similar when the monitor channel pointer points at other monitor channels 23, 23′.

Certain implementations of the invention comprise computer processors which execute software instructions that cause the processors to perform a method of the invention. The invention may also be provided in the form of a program product. The program product may comprise any medium which carries a set of computer-readable signals comprising instructions which, when executed by a data processor, cause the data processor to execute a method of the invention. The signals on the medium may be encrypted or compressed without departing from the invention. The program product may be in any of a wide variety of forms. The program product may comprise, for example, physical media such as magnetic data storage media including floppy diskettes, hard disk drives, optical data storage media including CD ROMs, DVDs, electronic data storage media including ROMs, flash memory, or the like or transmission-type media such as digital or analog communication links.

This invention may be embodied in at least the following ways: OXC switches configured to perform a method of the invention; controllers for OXC switches; a medium carrying computer-readable instructions for controllers of OXC switches; and a method for calibrating an OXC switch.

Where a component (e.g. a software process, processor, assembly, device, circuit, etc.) is referred to herein, unless otherwise indicated, reference to that component (including a reference to a “means”) should be interpreted as including, as equivalents of that component, any component which performs the function of the described component (i.e., that is functionally equivalent), including components which are not structurally equivalent to the disclosed structure, provided that they perform the function in the illustrated exemplary embodiments of the invention.

As will be apparent to those skilled in the art in the light of the foregoing disclosure, many alterations and modifications are possible in the practice of this invention without departing from the spirit or scope thereof. For example:

Photodetectors 27, 27′ (see FIG. 3) are optional. Photodetectors 27, 27′ may comprise photodiodes, photo-transistors, CCD devices, photo-resistors, position sensitive detectors or other photosensitive devices, for example. Photodetectors 27, 27′ may be positioned on one or both sides of the switch and may have a known spatial relationship to one or more switching units 22, 22′ and/or one or more monitor channels 23, 23′. The known spatial relationship may be stored in memory 302. In addition to being used to calculate approximate transformations according to method 330, photodetectors 27, 27′ may be used to help establish optical connections between switching units 22, 22′ (or monitor channels 23, 23′). Photodetectors 27, 27′ may be used, for example, in establishing an initial optical connection between a new switching unit 22, 22′ and a monitor channel 23, 23′ in block 320 of method 300. The new switching unit 22, 22′ can be caused to emit radiation toward the approximate location associated with a photodetector 27. The new switching unit 22, 22′ can be controlled to scan the radiation until it is detected by photodetector 27 and the intensity of the radiation received at photodetector 27 is maximized. Then, using the known spatial relationship between photodetector 27 and a monitor channel 23, 23′, the new switching unit 22, 22′ can be directed to coordinates which are approximately those associated with the monitor channel 23, 23′. Using photodetectors 27, 27′ in this manner may be advantageous, because a photodetector may generally have a wider acceptance angle for incoming radiation than an optical fiber. Because of the wider acceptance angle, a photodetector does not itself have to be aligned to receive radiation and to maximize the optical throughput.

Many architectures and configurations for an OXC switch are possible. Application of the invention is not limited to the architecture of FIG. 2. For example, side A chassis 16 and side B chassis 16′ of FIG. 2 may have one or more folding mirrors interposed therebetween in order to conform the switch to required dimensions. Alternatively, a switch may have a single chassis that opposes a mirror, such that optical communication signals may be transmitted and received by fibers in the same chassis.

Calibration method 300 (FIG. 7), transformation approximation method 330 (FIG. 12), initialization method 400 (FIG. 9) and recalibration method 500 (FIG. 11) do not depend on the type of actuator 209, 209′, actuation system 208, 208′, position sensor 211, 211′ or the position measurement system 210, 210′ (see FIG. 1) used to implement the switching units 22, 22′, the monitor channels 23, 23′ or the OXC switch itself. Accordingly, the invention should be understood to include any devices, components and systems capable of acting in a manner equivalent to actuator 209, 209′, actuation system 208, 208′, position sensor 211, 211′ and position measurement system 210, 210′ described above.

The illustrated and described embodiments of calibration method 300 (FIG. 7), transformation approximation method 330 (FIG. 12), initialization method 400 (FIG. 9) and recalibration method 500 (FIG. 11) are only particular examples of the methods of the present invention. These methods can be expanded to other situations.

In many cases, the blocks of calibration method 300, transformation approximation method 330, initialization method 400 and recalibration method 500 need not be implemented in the particular order or in the particular execution sequence illustrated and described above. For example, in initialization method 400 monitor channels 23 and 23′ may be calibrated in any order or may be calibrated in parallel. Side A monitor channels 23 may be calibrated before (or concurrently with) side B monitor channels 23′. The invention should be understood to accommodate some rearrangement of the order of certain blocks within calibration method 300, transformation approximation method 330, initialization method 400 and recalibration method 500, provided that such rearrangement does not adversely affect the outcome. Moreover, those skilled in the art will appreciate that the division of calibration method 300, transformation approximation method 330, initialization method 400, and recalibration method 500 into blocks is largely for illustrative and explanatory purposes. The processes discussed or shown as part of particular blocks need not be entirely independent from one another. In addition, the execution sequence of processes discussed or shown as part of particular blocks may occur, at least partially, concurrently with one another. For example, as discussed above, during the calibration of monitor channel 23A in block 420 of initialization method 400, controller 47 establishes an optical connection between side A monitor channel 23A and each of side B monitor channels 23A′, 23B′, 23C′. The position information and calibration parameters gleaned from these optical connections made in block 420 may be used as part of the calibration of the side B monitor channels 23A′, 23B′, 23C′ in blocks 440, 442, 444 respectively. Similar modifications may be made to the order and execution sequence of calibration method 300, transformation approximation 330 and recalibration method 500. The blocks discussed above and illustrated in FIGS. 7, 9, 11 and 12 should be understood to be used for illustrative and explanatory purposes. The invention is not limited by whether a particular process described above is included in one block or in another block, provided that the processes are achieved in a manner that achieves the objectives of the invention.

As described above method 330 is implemented by transmitting radiation from various switching units 22, 22′ or monitor channels 23, 23′. In an alternative embodiment, method 330 could also be performed by receiving radiation at various switching units 22, 22′ or monitor channels 23, 23′. For example, “flood-type” radiation sources may be provided at similar locations as photodetectors 27′, 27 and the fiber ends 13, 13′ of switching units 22, 22′ (or the fiber ends 53, 53′ of monitor channels 23, 23′) may be moved until the radiation inserted into the corresponding fibers 12, 12′ (or 52, 52′) is maximized.

The OXC switch apparatus described above comprises four side A monitor channels 23 and four side B monitor channels 23′. The methods of the present invention may be implemented with more or fewer monitor channels.

In some embodiments of the invention, the fiber ends 13, 13′, 53, 53′ of switching units 22, 22′ and monitor channels 23, 23′ may be moveable in only one dimension. In such a case, only two monitor channels are required to define a global coordinate system and only two points to calculate transformations back and forth between the global coordinate system and local coordinate systems.

In addition or in the alternative to having moving fiber ends, switching units 22, 22′ and monitor channels 23, 23′, according to some embodiments of the invention, may comprise other optical elements with suitable actuators that cause the other optical elements to move in one, two or three dimensions to facilitate making selected optical connections. Such embodiments of the invention may also comprise suitable position sensors to measure the positions of the moveable optical elements. Those skilled in the art will appreciate that the propagation path of an optical communication signal transmitted from switching units 22, 22′ and monitor channels 23, 23′(or received by fibers 12, 12′, 52, 52′) may be altered by controlling the position and/or orientation of one or more other optical elements. In addition to fiber ends, other moveable optical elements may include, for example: flat or curved mirrors; lenses; prisms; gratings; moveable or deformable micromachined mirrors, lenses or ribbons and/or any combination of these elements. The invention should be understood to include switching units comprising such other moveable optical elements. The methods of the present invention may also be applied to switches incorporating such other moveable optical elements. Examples of switches which incorporate a moveable optical element to effect switching are described in U.S. Pat. Nos. 6,097,858 and 6,097,860.

The above description of the methods of the invention involves the calculation and use of transformations that map coordinates in a local coordinate system of a switching unit 22, 22′ or a monitor channel 23, 23′ to a corresponding global coordinate system. Wherever such transformations are described, it should be understood that the inverse transformation may also be calculated (or used) to map coordinates in the global coordinate system to the local coordinate system of a switching unit 22, 22′ or a monitor channel 23, 23′. More particularly, the discussion of recalibration method 500 describes the division of transformation matrix T into a local component Tₗ and a global component T_{g}. A similar division may be employed for the inverse transformation, such that the inverse transformations may also be updated from time to time according to recalibration method 500.

The breakdown of the transformation matrix T into a local component Tₗ and a global component T_{g} is an example of how the transformation matrix T could be broken down into components. T_{g} represents a global matrix that may be used to update the overall transformation matrix T to account for changes in a variety of physical parameters. In addition or in the alternative, the transformation matrix T_{g} could be further broken down into different component matrices, where separate global component matrices may be dependent on one or more particular physical parameters. For example, the matrix T_{g} could be broken down into two global component matrices T_{gl} and T_{gt}, where T_{gl} represents a generalized global matrix and T_{gt} represents a global matrix that is dependent on temperature only. In such a case, T=TₗT_{gl}T_{gt}. A separate temperature sensor may be used to measure the temperature and update the matrix T_{gt} accordingly. The dependence of the elements of the matrix T_{gt} on temperature could be determined empirically or may be determined, for example, by parameters such as the coefficient of expansion of the materials used to form the support structure for the OXC switch. T_{gl}, which represents a variety of other physical parameters, could be updated as described in method 500. The storage of position information in a global coordinate system is not necessary to make use of monitor channels 23, 23′. Even without a global coordinate system, monitor channels 23, 23′ may be used to calibrate, initialize and recalibrate a switch without interrupting the transmission and switching of optical communication signals. For example, for each switching unit 22, 22′, a controller may store positions associated with all or a suitable subset of the opposing switching units 22′, 22 (and monitor channels 23′, 23) in the local coordinate system of that switching unit. In such a case, initializing the switch may involve defining a “monitor channel coordinate system” (i.e. used in conjunction with the monitor channels). Calibrating a new side A switching unit 22 may involve establishing an optical connection between the new side A switching unit 22 and each opposing monitor channel 23′ and using this position information to calculate transformations back and forth between the local coordinate system of the new side A switching unit 22 and the monitor channel coordinate system. Controller 47 may then use these transformations to predict and store the positions associated with side B switching units 22′ in the local coordinate system of new side A switching unit 22. Controller 47 may still make use of monitor channels 23, 23′ and the transformations to and from the monitor channel coordinate system to recalibrate the switch (i.e. update the switch calibration information). In such a case, controller 47 may detect drift (without interrupting the transmission and switching of optical communication signals) by creating optical connections between opposing monitor channels 23, 23′. If required, controller 47 may then update the calibration information that has been stored for each switching unit 22, 22′ using the transformations back and forth between the monitor channel coordinate system and the local coordinate systems of each switching unit 22, 22′.

In the above description, “monitor channels” 23, 23′ and “switching units” 22, 22′ are distinguished from one another for clarity. Monitor channels could differ in construction from switching units. In the alternative, switching units 22, 22′ may be constructed in the same manner, or substantially the same manner, as monitor channels 23, 23′. Any switching unit 22, 22′ may be configured to function as a monitor channel 23, 23′. The term “monitor channel” is used herein to distinguish the functionality of switching units being used as monitor channels from the functionality of switching units being used to carry optical communication signals.

Accordingly, the scope of the invention is to be construed in accordance with the substance defined by the following claims.

What is claimed is:

1. A method for calibrating an optical switch, the method comprising:
establishing optical connections between a first optical signal carrier and each of a plurality of optical devices;
when the optical connection is established with each optical device, determining, from a control system corresponding to the first optical signal carrier, coordinates associated with the optical device in a local coordinate system of the first optical signal carrier; and,
computing a transformation between the local coordinate system of the first optical signal carrier and a second coordinate system based on the determined coordinates.

2. A method according to claim 1, wherein the second coordinate system is a global coordinate system common to a plurality of optical signal carriers.

3. A method according to claim 1, wherein each of the optical devices comprises a photodetector and establishing optical connections between the first optical signal carrier and each of the plurality of optical devices comprises establishing an optical connection between the first optical signal carrier and each of the photodetectors.

4. A method according to claim 3, wherein, for each optical device, determining coordinates associated with the optical device comprises determining coordinates associated with the photodetector corresponding to the optical device.

5. A method according to claim 4, wherein computing the transformation between the local coordinate system of the first optical signal carrier and the second coordinate system comprises creating a set of equations by inserting the determined coordinates associated with the photodetectors and known coordinates associated with the photodetectors in the second coordinate system into a transformation equation and solving the set of equations.

6. A method according to claim 5, wherein computing the transformation between the local coordinate system of the first optical signal carrier and the second coordinate system comprises creating a plurality of sets of equations, obtaining a solution for each set of equations and averaging the plurality of solutions.

7. A method according to claim 5 comprising establishing an optical connection between a selected one of a plurality of other optical signal carriers and the first optical signal carrier by using the transformation to transform coordinates associated with the selected other optical signal carrier from the second coordinate system to local coordinates in the local coordinate system of the first optical signal carrier and moving an optical element corresponding to the first optical signal carrier in response to the local coordinates.

8. A method according to claim 7, wherein the optical element corresponding to the first optical signal carrier comprises one or more of: a moveable lens; a moveable mirror; a moveable optical fiber; and a moveable prism.

9. A method according to claim 4, wherein, for each photodetector, determining coordinates associated with the photodetector comprises maximizing an intensity throughput of the optical connection between the first optical signal carrier and the photodetector.

10. A method according to claim 9, wherein the first optical signal carrier comprises a movable optical element, the control system moves the movable optical element to a position determined by a set of optical signal carrier coordinates and, for each photodetector, determining coordinates associated with the photodetector comprises determining values of the set of optical signal carrier coordinates when the intensity throughput of the optical connection between the first optical signal carrier and the photodetector is substantially maximized.

11. A method according to claim 10, wherein the moveable optical element comprises one or more of: a moveable lens; a moveable mirror; a moveable optical fiber; and a moveable prism.

12. A method according to claim 9, wherein maximizing an intensity throughput of the optical connection comprises:
measuring an intensity throughput of the optical connection; and
moving an optical element corresponding to the first optical signal carrier through a range of positions until the measured intensity throughput is substantially maximized.

13. A method according to claim 3, wherein the photodetectors comprise one or more of: a photodiode, a phototransistor, a CCD device, a photoresistor and a position sensitive detector.

14. A method according to claim 1, wherein each of the optical devices comprises a monitor channel and establishing optical connections between the first optical signal carrier and each of the plurality of optical devices comprises establishing an optical connection between the first optical signal carrier and each of the monitor channels.

15. A method according to claim 14, wherein establishing the optical connection between the first optical signal carrier and each of the monitor channel comprises at least one of:
(a) transmitting an optical signal from the first optical signal carrier and receiving the optical signal at the monitor channel; and
(b) transmitting an optical signal from the monitor channel and receiving the optical signal at the first optical signal carrier.

16. A method according to claim 15, wherein receiving the optical signal at the monitor channel comprises receiving the optical signal at an optical signal carrier corresponding to the monitor channel and transmitting the optical signal from the monitor channel comprises transmitting the optical signal from an optical signal carrier corresponding to the monitor channel.

17. A method according to claim 14, wherein, for each optical device, determining coordinates associated with the optical device comprises determining coordinates associated with the monitor channel corresponding to the optical device.

18. A method according to claim 17, wherein computing the transformation between the local coordinate system of the first optical signal carrier and the second coordinate system comprises creating a set of equations by inserting the determined coordinates associated with the monitor channels and known coordinates associated with the monitor channels in the second coordinate system into a transformation equation and solving the set of equations.

19. A method according to claim 18, wherein the transformation equation has a form:
$$[ \begin{matrix}\begin{matrix}X \\ Y\end{matrix} \\ 1\end{matrix} ] = T [ \begin{matrix}\begin{matrix}x \\ y\end{matrix} \\ 1\end{matrix} ]$$
or a mathematical equivalent thereof.

20. A method according to claim 18, wherein computing the transformation between the local coordinate system of the first optical signal carrier and the second coordinate system comprises creating a plurality of sets of equations, obtaining a solution for each set of equations and averaging the plurality of solutions.

21. A method according to claim 18 comprising establishing an optical connection between a selected one of a plurality of other optical signal carriers and the first optical signal carrier by using the transformation to transform coordinates associated with the selected other optical signal carrier from the second coordinate system to local coordinates in the local coordinate system of the first optical signal carrier and moving an optical element corresponding to the first optical signal carrier in response to the local coordinates.

22. A method according to claim 21, wherein the optical element corresponding to the first optical signal carrier comprises one or more of: a moveable lens; a moveable mirror; a moveable optical fiber; and a moveable prism.

23. A method according to claim 17, wherein, for each monitor channel, determining coordinates associated with the monitor channel comprises maximizing an intensity throughput of the optical connection between the first optical signal carrier and the monitor channel.

24. A method according to claim 23, wherein the first optical signal carrier comprises a movable optical element, the control system moves the movable optical element to a position determined by a set of optical signal carrier coordinates and, for each monitor channel, determining coordinates associated with the monitor channel comprises determining values of the set of optical signal carrier coordinates when the intensity throughput of the optical connection between the first optical signal carrier and the monitor channel is substantially maximized.

25. A method according to claim 24, wherein the moveable optical element comprises one or more of: a moveable lens; a moveable mirror; a moveable optical fiber; and a moveable prism.

26. A method according to claim 23 comprising, when the intensity throughput of the optical connection is maximized, recording coordinates of a moveable optical element corresponding to the first optical signal carrier and coordinates of a moveable optical element corresponding to the monitor channel.

27. A method according to claim 26, wherein the moveable optical elements corresponding to the first optical signal carrier and the monitor channel comprise one or more of: a moveable lens; a moveable mirror; a moveable optical fiber; and a moveable prism.

28. A method according to claim 23, wherein maximizing an intensity throughput of the optical connection comprises:
measuring an intensity throughput of the optical connection; and
moving an optical element corresponding to the monitor channel through a range of positions until the measured intensity throughput is substantially maximized.

29. A method according to claim 28, wherein maximizing an intensity throughput of the optical connection comprises moving an optical element corresponding to the first optical signal carrier through a range of positions until the measured intensity throughput is substantially maximized.

30. A method according to claim 16, wherein the first optical signal carrier is an optical fiber and the optical signal carrier corresponding to the monitor channel is an optical fiber.

31. A method according to claim 14 comprising:
when the optical connection between the first optical signal carrier and the and the monitor channel is established, determining, from a control system corresponding to the monitor channel, first coordinates associated with the first optical signal carrier in a local coordinate system of the monitor channel; and
based upon the first coordinates, determining second coordinates associated with the first optical signal carrier.

32. A method according to claim 31, wherein determining the second coordinates comprises transforming the first coordinates into a global coordinate system.

33. A method according to claim 31 comprising controlling an actuator, based upon the second coordinates, to establish an optical connection between the first optical signal carrier and a second optical signal carrier.

34. A method according to claim 33, wherein controlling the actuator to establish the optical connection between the first and second optical signal carriers comprises transforming the second coordinates into third coordinates in a reference frame local to a control system of the second optical signal carrier.

35. A method according to claim 33, wherein determining the second coordinates comprises transforming the first coordinates into a reference frame local to a control system of the second optical signal carrier.

36. A method according to claim 33, wherein the first and second optical signal carriers each comprise an optical fiber and establishing the optical connection between the first and second optical signal carriers comprises moving ends of the optical fibers, so that optical signals emitted by one of the optical fibers are received by an other one of the optical fibers.

37. A method according to claim 31, wherein determining first coordinates associated with the first optical signal carrier comprises maximizing an intensity throughput of the optical connection between the first optical signal carrier and the monitor channel.

38. A method according to claim 37, wherein the monitor channel comprises a movable optical element, the control system moves the movable optical element to a position determined by a set of monitor channel coordinates and determining first coordinates associated with the first optical signal carrier comprises determining values of the set of monitor channel coordinates when the intensity throughput of the optical connection between the first optical signal carrier and the monitor channel is substantially maximized.

39. A method according to claim 38, wherein the moveable optical element comprises one or more of: a moveable lens; a moveable mirror; a moveable optical fiber; and a moveable prism.

40. A method according to claim 37 comprising, when the intensity throughput of the optical connection is maximized, recording coordinates of a moveable optical element corresponding to the monitor channel and coordinates of a moveable optical element corresponding to the first optical signal carrier.

41. A method according to claim 40, wherein the moveable optical elements corresponding to the monitor channel and the first optical signal carrier comprise one or more of: a moveable lens; a moveable mirror; a moveable optical fiber; and a moveable prism.

42. A method according to claim 41 comprising determining global coordinates associated with the first optical signal carrier in a global coordinate system based, in part, on the recorded coordinates of the optical element corresponding to the monitor channel.

43. A method according to claim 42, wherein determining global coordinates associated with the first optical signal carrier in a global coordinate system comprises:
for each monitor channel, recording coordinates of the optical element corresponding to the monitor channel when an intensity throughput of an optical connection between the first optical signal carrier and the monitor channel is substantially maximized;
transforming the recorded coordinates of the optical element corresponding to each of the plurality of monitor channels into global coordinates in a global coordinate system; and
averaging the global coordinates.

44. A method according to claim 42 comprising creating an optical connection between the first optical signal carrier and a selected one of a plurality of other optical signal carriers using the global coordinates associated with the first optical signal carrier.

45. A method according to claim 44, wherein creating an optical connection between the first optical signal carrier and the selected other optical signal carrier comprises transforming the global coordinates associated with the first optical signal carrier to local coordinates in a local coordinate system corresponding to the selected other optical signal carrier and moving an optical element corresponding to the selected other optical signal carrier in response to the local coordinates.

46. A method according to claim 44 comprising, after creating the optical connection between the first optical signal carrier and the selected other optical signal carrier, transmitting an optical communication signal between the first optical signal carrier and the selected other optical signal carrier.

47. A method according to claim 1, wherein:
the first optical signal carrier comprises a side A monitor channel and each of the plurality of optical devices comprises a side B monitor channel;
establishing optical connections between the first optical signal carrier and each of the plurality of optical devices comprises establishing optical connections between the side A monitor channel and each of the plurality of side B monitor channels;
when the optical connection is established with each optical device, determining coordinates associated with the optical device comprises determining, from a control system corresponding to the side A monitor channel, coordinates associated with the side B monitor channel in a local coordinate system of the side A monitor channel; and
computing a transformation between the local coordinate system of the first optical signal carrier and the second coordinate system comprises computing a transformation between the local coordinate system of the side A monitor channel and a side A coordinate system based upon the determined coordinates associated with the side B monitor channels.

48. A method according to claim 47 comprising defining the side A coordinate system prior to establishing optical connections between the side A monitor channel and each of the plurality of side B monitor channels.

49. A method according to claim 48, wherein defining the side A coordinate system comprises defining the side A coordinate system based on nominal coordinates associated with each of the plurality of side B monitor channels.

50. A method according to claim 49, wherein defining the side A coordinate system comprises one of:
defining a one-dimensional side A coordinate system based upon nominal coordinates associated with two side B monitor channels; and,
defining a two-dimensional side A coordinate system based upon nominal coordinates associated with three side B monitor channels.

51. A method according to claim 49, wherein computing the transformation between the local coordinate system of the side A monitor channel and the side A coordinate system comprises creating a set of equations by inserting the determined coordinates associated with the side B monitor channels and the nominal coordinates associated with the side B monitor channels into a transformation equation and solving the set of equations.

52. A method according to claim 47 comprising repeating the method of claim 49 for each of a plurality of side A monitor channels.

53. A method according to claim 47 wherein determining coordinates associated with the side B monitor channel comprises maximizing an intensity throughput of the optical connection between the side A monitor channel and the side B monitor channel.

54. A method according to claim 47 comprising determining coordinates associated with an additional side B optical signal carrier in the side A coordinate system by:
establishing an optical connection between the additional side B optical signal carrier and the side A monitor channel;
maximizing an intensity throughput of the optical connection;
when the intensity throughput of the optical connection is maximized, determining, from a control system corresponding to the side A monitor channel, coordinates associated with the additional side B optical signal carrier in a local coordinate system of the side A monitor channel; and
transforming the coordinates associated with the additional side B optical signal carrier from a local coordinate system of the side A monitor channel to the side A coordinate system using the transformation.

55. A method according to claim 47, wherein each side A and side B monitor channel comprises an optical fiber.

56. A method according to claim 55, wherein establishing an optical connection between the side A monitor channel and the side B monitor channel comprises moving ends of the optical fibers corresponding to the side A and side B monitor channels, so that optical signals emitted by one of the optical fibers are received by the other one of the fibers.

57. A method according to claim 47 comprising:
providing a plurality of side A optical signal carriers and a plurality of side B optical signal carriers;
based upon the transformation, generating new calibration information relating to at least one of: the plurality of side A optical signal carriers and the plurality of side B optical signal carriers signal carriers; and
if required, updating existing calibration information by replacing it with new calibration information.

58. A method according to claim 57 comprising performing the method of claim 59 while substantially continuously transmitting optical communication signals between one or more of the side A optical signal carriers and one or more of the side B optical signal carriers.

59. A method according to claim 57 comprising comparing the transformation with a previously calculated transformation to determine whether existing calibration information should be updated.

60. A method according to claim 57 comprising comparing the determined coordinates associated the side B monitor channels with previously determined coordinates associated with the side B monitor channels to determine whether the existing calibration information should be updated.

61. A method according to claim 57 comprising, prior to updating the existing calibration information, comparing the new calibration information to the existing calibration information and verifying whether to replace the existing calibration information with the new calibration information.

62. A method according to claim 61, wherein verifying whether to replace the existing calibration information with the new calibration information comprises comparing a magnitude of a difference between the new calibration information and the existing calibration information to a threshold, and, if the magnitude is less than the threshold, continuing to replace the existing calibration information with the new calibration information.

63. A method for calibrating an optical cross-connect switch, the method comprising:
establishing an optical connection between a monitor channel of the switch and a first optical signal carrier of the switch;
determining, from a control system corresponding to the monitor channel, first coordinates associated with the first optical signal carrier;
based upon the first coordinates, determining second coordinates associated with the first optical signal carrier and, using the second coordinates, controlling an actuator to establish an optical connection between the first optical signal carrier and a second optical signal carrier of the switch.

64. An optical cross-connect switch comprising:
a plurality of side A optical signal carriers and a plurality of side B optical signal carriers;
means for transmitting optical communication signals between any one of the side A optical signal carriers and any one of the side B optical signal carriers;
one or more side A monitor channels and one or more side B monitor channels;
a controller connected to the one or more side A monitor channels and the one or more side B monitor channels and configured to generate optical connections between the one or more side A monitor channels and the one or more side B monitor channels without disturbing transmission of optical communication signals between the side A optical signal carriers and the side B optical signal carriers and to use information obtained from these optical connections to update calibration information relating to at least one of: the plurality of side A optical signal carriers and the plurality of side B optical signal carriers.

65. A switch according to claim 64, wherein each side A and side B monitor channel comprises a moveable optical element.

66. A switch according to claim 65, wherein the controller is configured to generate optical connections between a selected one of the one or more side A monitor channels and a selected one of the one or more side B monitor channels by moving the optical elements corresponding to the selected side A monitor channel and the selected side B monitor channel.

67. A switch according to claim 66, wherein the controller is configured to use information regarding the coordinates of the optical element corresponding to the selected side A monitor channel and the coordinates of the optical element corresponding to the selected side B monitor channel to update calibration information relating to at least one of: the plurality of side A optical signal carriers and the plurality of side B optical signal carriers.
